(19) United States
(12) Patent Application Publication
(10) Pub. No.: US 2023/0043847 A1
(43) Pub. Date: Feb. 9, 2023

(54) BEAMFORMING AND CARRIER AGGREGATION

(71) Applicant: Fraunhofer-Gesellschaft zur Foerderung der angewandten Forschung e.V., Munich (DE)

(72) Inventors: Thomas HAUSTEIN, Berlin (DE); Ramez ASKAR, Berlin (DE); Paul Simon Holt LEATHER, Berlin-Schlachtensee (DE); Mathis SCHMIEDER, Berlin (DE); Jasmina MCMENAMY, Berlin (DE)

(21) Appl. No.: 17/887,171

(22) Filed: Aug. 12, 2022

Related U.S. Application Data
(63) Continuation of application No. PCT/EP2021/053236, filed on Feb. 10, 2021.

(30) Foreign Application Priority Data
Feb. 13, 2020 (EP) 20157282.3
Aug. 25, 2020 (EP) 20192697.9

(51) Int. Cl. H04B 7/06; H04L 5/00

(52) U.S. Cl. CPC H04B 7/0617; H04B 7/0695; H04L 5/0094; H04B 7/0628

(57) ABSTRACT

A device configured for operating in a wireless communication network and for performing communication with a communication partner within the wireless communication network by exchanging a wireless signal is configured for communicating with the communication partner using a beamforming technique to form a transmit beam pattern being a beam pattern selected from a plurality of transmit beam patterns being formable by the device. The device is configured for providing, responsive to a trigger event, a number of transmit beam patterns being at least a subset of the plurality of formable transmit beam patterns to the communication partner or a different entity of the wireless communication network. The device is configured for receiving feedback information relating to the beam patterns of the number of beam patterns; and for using at least one of the provided number of beam patterns based on the feedback information as a selected beam pattern.

### CROSS-REFERENCE TO RELATED APPLICATIONS

This application is a continuation of copending International Application No. PCT/EP2021/053236, filed Feb. 10, 2021, which is incorporated herein by reference in its entirety, and additionally claims priority from European Applications Nos. EP 20157282.3, filed Feb. 13, 2020, and 20192697.9, Aug. 25, 2020, which are all incorporated herein by reference in their entirety.

The present invention relates to a device, a wireless communication network, a method for operating a device, and a method for assessing a link performance of a device, in particular, a device being capable of combining beamforming and carrier aggregation. The present invention further relates to in general to the combining of beamforming and carrier aggregation.

### BACKGROUND OF THE INVENTION

Beamforming or spatial filtering is a signal processing technique used in antenna arrays for directional signal transmission or reception. This is achieved by combining elements in an antenna array in such a way that signals arriving from particular angles experience constructive interference while others experience destructive interference. Beamforming can be used at both the transmitting and receiving ends of a wireless link in order to achieve spatial selectivity. The improvement compared with omnidirectional reception/transmission is known as the directivity of the array. For systems that operate above-6 GHz, and in the so-called millimeter-wave range (e.g. >24 GHz and <100 GHz), beamforming is essential as its highly directional transmission compensates for the significant propagation and penetration losses. Digital beamforming provides greatest flexibility as it enables the connection of each antenna element to its own RF chain. At mmWave frequencies however, and when a large number of antenna elements are used, digital beamforming can become prohibitive in terms of complexity, power consumption and cost in general [1]. Analogue beamforming, on the other hand, is normally implemented using phase shifters, attenuators and electrical delays. It has limited flexibility in dynamically controlling the radiation pattern—especially when multibeam patterns are considered—but is an attractive option mostly due its relative simplicity and the fewer number of RF chains needed. For these reasons, the currently proposed mmWave system solutions focus on hybrid configurations, in which beamforming is performed in both the digital and analogue domains. In hybrid beamforming, an analogue beamformer typically consists of a number of sub-arrays, in which each sub-array has a dedicated RF chain and potentially a set of phase shifters, delay lines and attenuators allowing to control the antenna radiation pattern of the sub-array [1].

Carrier aggregation is a technique used in wireless communication to increase the data rate per user, whereby multiple frequency blocks of the system bandwidth are assigned to the same user. A so called component carrier is describing operating in a particular part of the spectrum and occupying a certain bandwidth (often called system bandwidth, e.g. in 4G-LTE this is 1.4 MHz, 5 MHz, 10 MHz, 20 MHz), in order to increase the allocated bandwidth per link beyond the bandwidth of a component carrier (CC) several CC can be aggregated while the positioning in spectrum can be adjacent or distributed/fragmented. The maximum possible data rate per user is increased the more frequency blocks/CC are assigned to a user. The sum data rate of a cell is increased as well as because of a better resource utilization. In addition, load balancing is possible with carrier aggregation. Carrier aggregation was first introduced in LTE release 10. There, multiple carriers can be transmitted in parallel to/from the same terminal/eNB, thus allowing for an increased bandwidth and correspondingly higher data rates per-link [2].

Thus, there is a need to improve network throughput.

### SUMMARY

An embodiment may have a device configured for operating in a wireless communication network and for performing communication with a communication partner within the wireless communication network by exchanging a wireless signal; wherein the device is configured for communicating with the communication partner using a beamforming technique to form a transmit beam pattern being a beam pattern selected from a plurality of transmit beam patterns being formable by the device; wherein the device is configured for providing, responsive to a trigger event, a number of transmit beam patterns being at least a subset of the plurality of formable transmit beam patterns to the communication partner or a different entity of the wireless communication network; wherein the device is configured for receiving feedback information relating to the beam patterns of the number of beam patterns; and wherein the device is configured for using at least one of the provided number of beam patterns based on the feedback information as a selected beam pattern; and wherein the device is configured for using an aggregation of carriers for the communication; wherein the device includes an antenna arrangement and a control unit configured for controlling the antenna arrangement for forming the selected transmit beam pattern for the aggregation of carriers.

Another embodiment may have a device configured for operating in a wireless communication network and for performing communication with a communication partner within the wireless communication network by exchanging a wireless signal; wherein the device is configured for transmitting, to an entity of the wireless communication network a capability information indicating a capability of the device to perform carrier aggregation and a capability to perform beamforming for the communication and/or receiving such capability information relating to another device.

According to another embodiment, a method for assessing a link performance of a device for a wireless communication system, wherein the device is to beamform a plurality of component carriers using common beamforming weights, the plurality of component carriers including at least a first component carrier (PCC) and a second component carrier (SCC), may have the steps of: (a) beamforming a first beam pattern for the first and second component carriers (PCC, SCC) using the common beamforming weights, wherein the common beamforming weights are selected such that the first beam pattern is optimized for the first component carrier (PCC) according to one or more predefined criteria, (b) measuring one or more signal metrics of the first and second component carriers (PCC, SCC) transmitted in accordance with the first beam pattern, (c) beamforming a second beam pattern for the first and second component carriers (PCC, SCC) using the common beamforming weights, wherein the common beamforming weights are selected such that the second beam pattern is optimized for the second component carrier (SCC) according to one or more predefined criteria, (d) measuring one or more signal metrics of the first and second component carriers (PCC, SCC) transmitted in accordance with the second beam pattern, and (e) comparing the one or more signal metrics measured in steps (b) and (d) for qualifying or quantifying the link performance.

According to another embodiment, a method for assessing a link performance of a device for a wireless communication system, wherein the device is to beamform a plurality of component carriers using respective beamforming weights, the plurality of component carriers including at least a first component carrier (PCC) and a second component carrier (SCC), may have the steps of: (a) beamforming a first beam pattern for the first component carrier (PCC) using first beamforming weights, wherein the first beamforming weights are selected such that the first beam pattern is optimized for the first component carrier (PCC) according to one or more predefined criteria, and beamforming a second beam pattern for the second component carrier (SCC) using second beamforming weights, wherein the second beamforming weights are selected such that the second beam pattern is optimized for the second component carrier (SCC) according to one or more predefined criteria, (b) measuring one or more signal metrics of the first component carrier (PCC) transmitted in accordance with the first beam pattern, and one or more signal metrics of the second component carrier (SCC) transmitted in accordance with the second beam pattern, and (c) comparing the signal metrics measured in step (b) for the first and second component carriers for qualifying or quantifying the link performance.

The inventors have found that for obtaining a high network throughput, techniques of beamforming and of carrier aggregation may be combined in a particular way. As beamforming is usually performed as controlling an antenna arrangement at a certain frequency range, this control mechanism may lack efficiency or preciseness when changing or modifying the frequency range, in particular, the size thereof as it is a purpose of the carrier aggregation. The inventors have found a suitable way to control an antenna arrangement by use of carrier aggregation with a combinatory or joint set of beamforming weights that is used for the frequency range being obtained by carrier aggregation.

According to an embodiment, a device configured for operating in a wireless communication network and for performing communication with a communication partner within the wireless communication network by exchanging a wireless signal is configured for communicating with the communication partner using a beamforming technique to form a transmit beam pattern being a beam pattern selected from a plurality of transmit beam patterns being formable by the device The device is configured for providing, responsive to a trigger event, a number of transmit beam patterns being at least a subset of the plurality of formable transmit beam patterns to the communication partner or a different entity of the wireless communication network; for receiving feedback information relating to the beam patterns of the number of beam patterns; for using at least one of the provided number of beam patterns based on the feedback information as a selected beam pattern; and for using an aggregation of carriers for the communication. The device comprises an antenna arrangement and a control unit configured for controlling the antenna arrangement for forming the selected transmit beam pattern for the aggregation of carriers. Thus, the control unit is configured for extending control of the beamforming in one carrier to the aggregation of carriers. This allows to obtain a high throughput even though deviating from the association of a single carrier to a specific set of beamforming weights to obtain a specific beam pattern optimized for this particular carrier. According to an embodiment, a wireless communication network comprises such a device.

According to an embodiment a device configured for operating in a wireless communication network and for performing communication with a communication partner within the wireless communication network by exchanging a wireless signal is configured for transmitting, to an entity of the wireless communication network a capability information indicating a capability of the device to perform carrier aggregation and a capability to perform beamforming for the communication and/or receiving such capability information relating to another device.

Further embodiments relate to methods for controlling such devices and to a computer program.

### BRIEF DESCRIPTION OF THE DRAWINGS

Embodiments of the present invention will be detailed subsequently referring to the appended drawings, in which:

FIGS. 1A-C show example diagrams representing plots of a radiated power or sensitivity formed with an example antenna arrangement having eight antenna elements being uniformly arranged in a linear array;

FIG. 2A shows a schematic block diagram of a network according to an embodiment having a device according to an embodiment;

FIG. 2B shows a schematic block diagram of the wireless communication network 200 illustrating the device 20 providing a first transmission beam pattern 16₁ based on beamforming weights 19₁ during a first instance of time and providing a second transmission beam pattern 16₂ based on beamforming weights 19₂ during a second instance of time which is disjoint to the first instance of time

FIG. 2C shows a schematic block diagram of the wireless communication network 200 illustrating the device 20 providing the transmission beam pattern 16₂ as the selected beam-pattern

FIG. 3A shows a schematic representation of two carriers of the wireless communication network arranged adjacent to each other in frequency, according to an embodiment;

FIG. 3B shows a schematic representation of the carriers of two carriers of the wireless communication network being arranged to each other non-adjacently, according to an embodiment;

FIG. 4 shows a schematic diagram representing a determination of different beamforming weights according to an embodiment;

FIG. 5 shows a schematic flowchart of a method according to an embodiment in which two carriers are aggregated;

FIG. 6 shows a schematic flowchart of a method in which at least three carriers are aggregated;

FIG. 7 shows a schematic flow chart of a method illustrated by an exchange of signals or messages according to an embodiment;

FIG. 8 shows a schematic flow chart of a method that may be used for operating a device;

FIG. 9A shows a schematic block diagram of a control unit according to an embodiment;

FIG. 9B shows a schematic representation of another control unit according to an embodiment;

FIG. 9C shows a schematic representation of a wireless communication network which may be the wireless communication network of FIG. 2;

FIG. 9D shows a schematic representation of a wireless communication network according to an embodiment having additional devices suffering interference;

FIG. 10 shows a schematic flowchart of a method according to an embodiment;

FIG. 11 shows a schematic block diagram of the wireless communication network of FIG. 2A in which the devices are capable for forming a transmission beam pattern respectively and a reception beam pattern;

FIG. 12A-D show schematic representation of different beamforming concepts;

FIG. 13A-C show different configurations of beamformers and antenna panels according to embodiments;

FIG. 14 schematically illustrates the effect of beam squinting in a device described herein;

FIG. 15 is a flow diagram illustrating a first embodiment of the inventive measuring or testing process assuming a user equipment using the same antenna for beamforming the first and second component carriers at the same time,

FIG. 16 is a flow diagram illustrating a second embodiment of the inventive measuring or testing process assuming a user equipment using different antennas for beamforming the first and second component carriers at the same time,

FIG. 17 illustrates a DUT mounted within a measurement chamber for measuring or testing a device described herein in accordance with embodiments of the present invention; and

FIG. 18 illustrates a coordinate system geometry based on IEEE Std 149-1979 and shows a relative angular configuration or direction between the DUT and the LA of FIG. 17 by the angles theta θ and phi ϕ.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Embodiments described herein relate to forming an antenna radiation pattern which may also be referred to as beam pattern. Techniques for forming such an antenna radiation pattern may be referred to as beamforming. Beamforming may be performed for both transmission and reception to implement or generate one or more directions of transmitting a radio signal, for receiving a radio signal respectively. Embodiments described herein relate to analog beamforming techniques as well as to digital beamforming techniques and, in particular, to hybrid beamforming techniques. That is, it is possible but not necessary that a beamforming network comprises a signal path to each antenna element of an antenna arrangement. In connection with carrier aggregation with hybrid beamforming on multiple antenna arrays, panels, subarrays or the like, it is possible that per panel/subarray/array independent or joint or independent selection of the set of beamforming weights may be applied to some or all of them whilst being optimized for Primary Component Carrier (PCC) and/or Secondary Component Carrier (SCC). That is, devices in accordance with embodiments may be configured for at least one of analogue beamforming, digital beamforming and hybrid beamforming (wherein hybrid beamforming comprises analogue and digital beamforming), for hybrid beamforming at which a set of beamforming weights associated with the selected or re-selected beam pattern is applied holistically to the antenna arrangement for the aggregation.

A beam or beam pattern to be formed in embodiments described herein may comprise at least one main lobe. This main lobe may be aimed to be controlled or steered or formed towards a specific direction along a line-of-sight (LoS) or non-line-of-sight (nLoS) path. The antenna radiation pattern may further comprise additional main lobes, one or more side lobes and nulls arranged between the lobes. Although not explicitly discussing additional main lobes, side lobes and nulls, embodiments are not limited to beams that comprise one main lobe only. Further, a radiation beam pattern may be obtained by forming a single beam pattern or as a combination of beam patterns.

Embodiments described herein further relate to an antenna arrangement. An antenna arrangement may comprise a plurality of antenna elements that are used to transmit or receive wireless energy representing a signal. Embodiments are related to a joint beamforming pre-coder for aggregated frequency bands or carriers. In the hybrid beamforming same is done in a hybrid fashion, allowing for the two frequencies (frequency bands) or covering a large bandwidth to be connected to a joined set of delay lines or phase shifters used to influence the phases going to or coming from particular antenna elements of an array antenna/antenna arrangement. For example, when connecting all antenna elements individually to a transceiver chain, individual beamforming weights may be chosen per sub-band/frequency band/carrier. Embodiments are in particular relevant for all kinds of hybrid beamforming where for individual antenna elements or groups of antenna elements (group antennas/sub-panel) a joined delay line/phase-shifter is applied on a digital, intermediate frequency (IF) and/or radio frequency (RF) signal.

Although embodiments described herein relate to a device comprising an antenna arrangement, this is not limiting embodiments to have a single antenna arrangement. Whilst an antenna arrangement may be understood as an antenna panel having a plurality of antenna elements (radiating elements or antennas) that are controlled individually, in groups or jointly by one or more beamforming networks, devices according to the present invention may alternatively comprise two or more antenna arrangements forming jointly an antenna structure that may also be referred to as an antenna arrangement. For example, such sub-panels may be arranged at different sides of the device so as to allow efficient beamforming along different main signs of a housing of the device or the like.

Embodiments described herein further relate to carrier aggregation. Although some embodiments are described herein whilst making reference to a primary component carrier (PCC) and a secondary component carrier (SCC) that is aggregated to the PCC and although some embodiments further relate to aggregate additional component carriers (CC), the embodiments are not limited to the specification given in mobile communication standards such as 4G, 5G or 6G. Embodiments may be implemented in connection with any wireless communication networks that relate to a combination of carrier aggregation by increasing an occupied bandwidth for communication whilst performing frequency-selective signal forming, in particular, beamforming.

Since a mechanical spacing of antenna elements that form an antenna array or antenna arrangement may be fixed, their electrical separation (for example, measured in terms of wavelength) will vary as a function of the frequency of operation. Generally speaking, the design of an antenna array may consider the requirements for operation over a given range of the frequencies. When such an array is combined with components needed to form or steer a beam in a given direction, the phase or electrical delay associated with those components might also be frequency dependent. In other words, at each frequency of operation, a different set of beamforming weights is needed to form the beam in a similar direction. This means that if the frequency of operation were to change while the beamformer weights are not, then the beam might not be formed appropriately. This could result in pattern formation errors (aberration), examples of which are not limited to include a beam misalignment, beam broadening, an increase in the level and/or width of side lobes and a decrease in a depth of nulls.

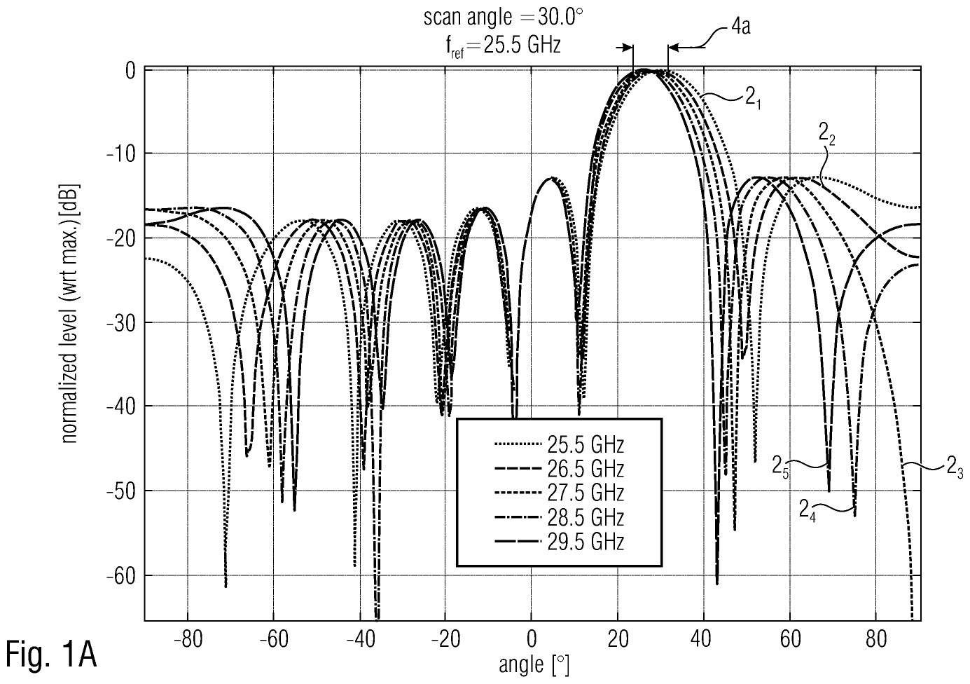

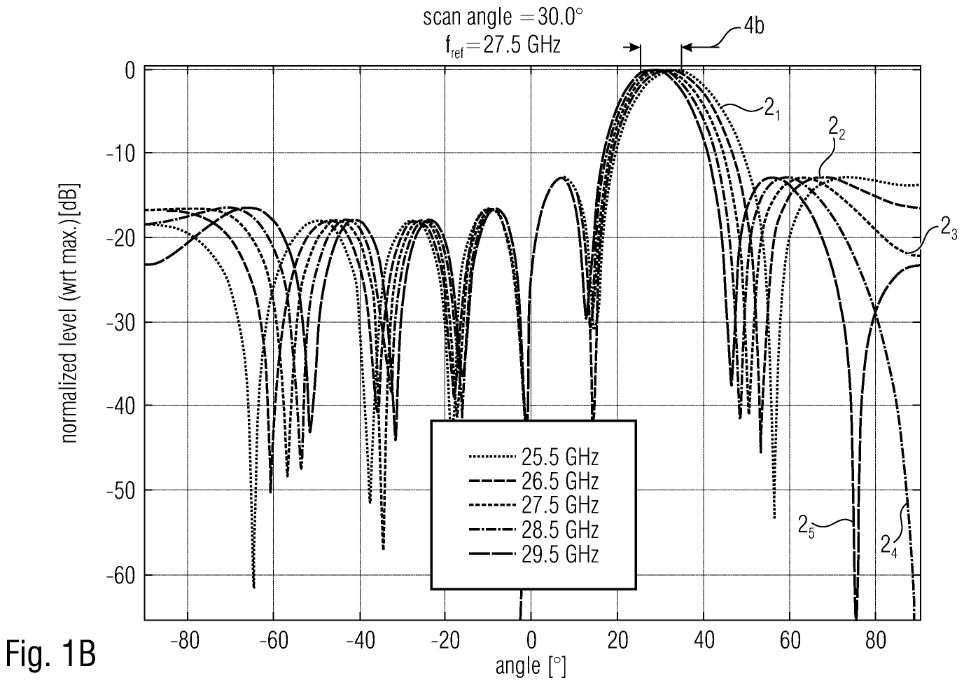

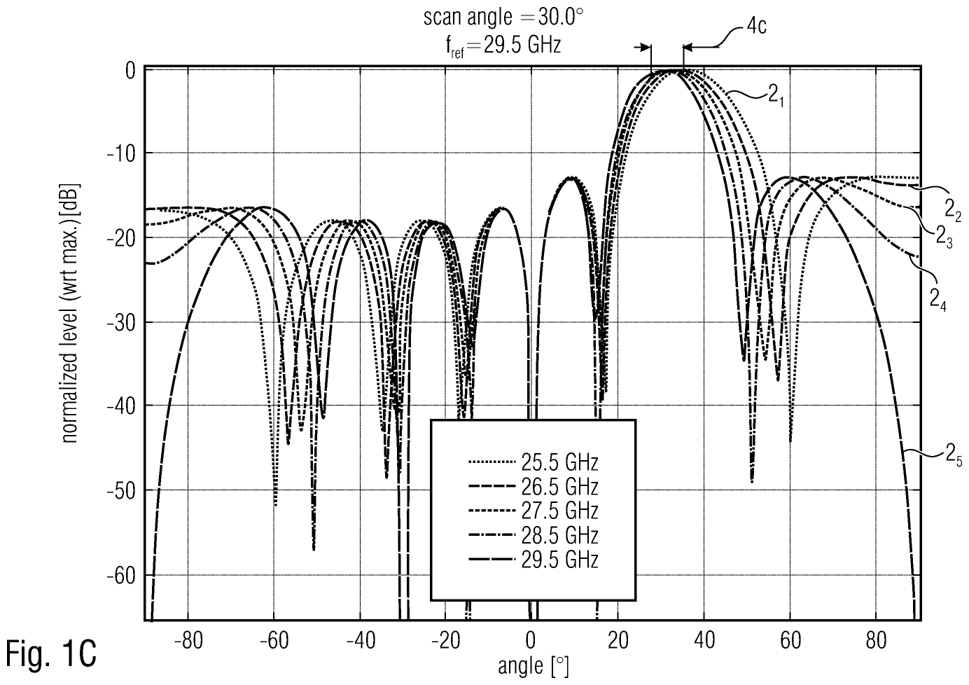

Examples of pattern operation are described in connection with FIG. 1A, FIG. 1B and FIG. 1C. FIGS. 1A-C show example diagrams represents plots 2₂, 2₂, 2₃, 2₄ and 2₅ of a radiated power (transmit beam) or sensitivity (receive beam) formed with an example antenna arrangement having eight antenna elements being uniformly arranged in a linear array. Whilst in FIG. 1A, the array is designed for operation at 25.5 GHz, the array of FIG. 1B is designed for operation at 27.5 GHz. The array in FIG. 1C is designed for operation at 29.5 GHz which means that the arrays in FIGS. 1A, 1B and 1C are implemented, for example, with different distances between the antenna elements. Plots 2₁ to 2₅ represent the transmit power or sensitivity along different angles at the abscissa as a normalized level value with respect to a maximum value in a logarithmic scale (ordinate). The plots are shown for different signal frequencies, center frequencies of the used frequency range respectively. Plot 2₁ represents a signal with a center frequency of 25.5 GHz, plot 2₂ represents a signal with a center frequency of 26.5 GHz, plot 2₃ represents a signal with a center frequency at 27.5 GHz, plot 2₄ represents a signal at 28.5 GHz and plot 2₅ represents a signal 29.5 GHz. As may be seen, although each antenna arrangement may be used to form each of the signals, each antenna arrangement corresponds to only one signal in view of a match of the center frequency and the design of the antenna arrangement. That is, the center frequency of the remaining four signals deviate from the frequency used for the design. This may lead to a spatial spread 4a (FIG. 1A), 4B (FIG. 1B), 4C (FIG. 1C) respectively in which the angle and thus direction of the formed beam deviates responsive to the changed frequency. This effect may be also be referred to as aberration.

As one may see, when changing the frequency of the beam, the direction may also vary when using the same beamforming weights. This effect may take place when using carrier aggregation in a comparable manner as, when aggregating carriers, the frequency range may broaden and/or the center frequency may vary. Therefore, when using the beamforming, a use of carrier aggregation may lead to the misalignment/non-congruency of the beam patterns at PCC and SCC.

In other words, to illustrate pattern aberration due to the effect of the one frequency being used to design beamforming weights while operating at different frequencies, FIGS. 1A-C show the array factor of an eight-element uniform linear array for which the weights were designed for operation at 25.5 GHz, 27.5 GHz and 29.5 GHz, respectively.

As carrier aggregation may be understood as a requirement to an antenna array to operate over a potentially broader span of frequency, it is unlikely that optimal performance is achievable for all frequencies/frequency bands of interest. Some form of decision is thus needed to determine beamforming weights in accordance with a set of criteria that consider, amongst other things, the optimal performance of the array across all frequencies associated with any particular carrier aggregation scheme. In FIGS. 1A-C, the examples of pattern aberration due to frequency effects illustrated show that carrier aggregation is to be considered in determining beamforming weights.

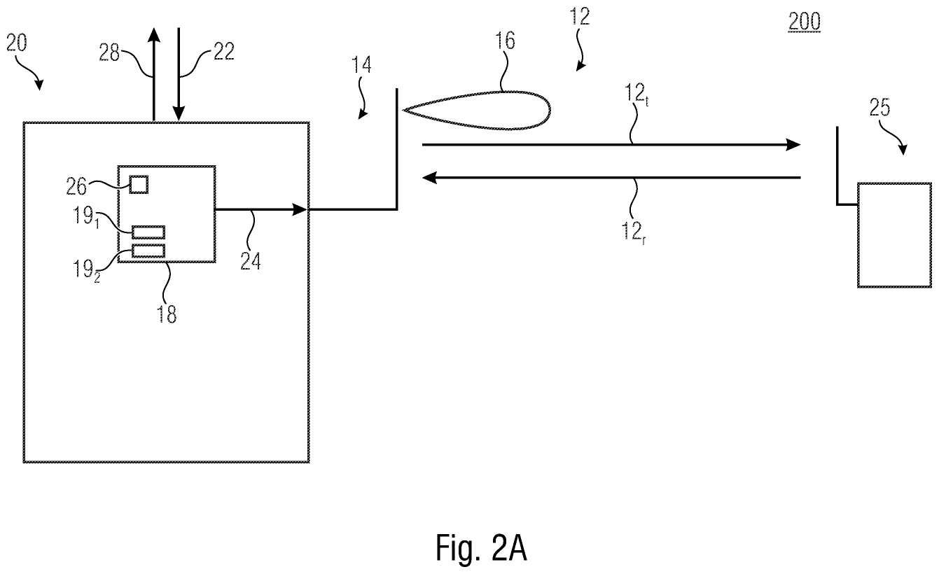

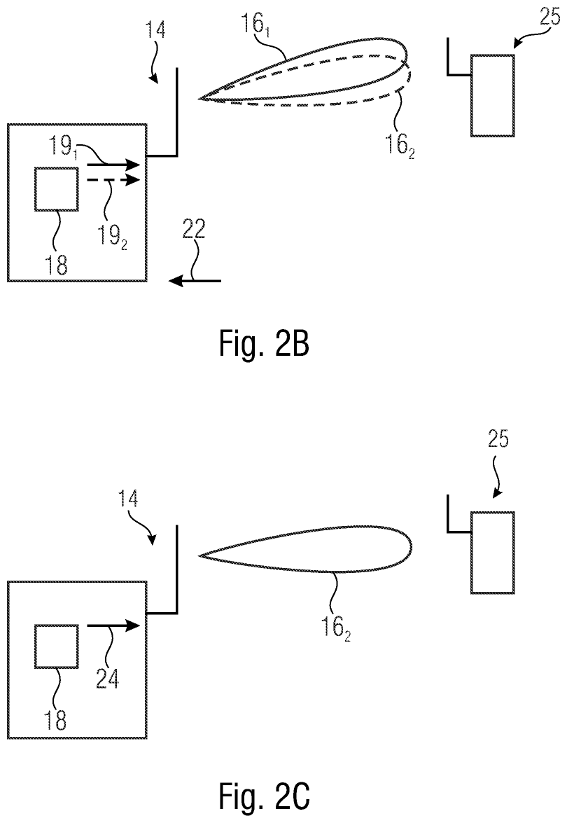

FIG. 2A shows a schematic block diagram of a device 20 according to an embodiment. The device 20 is configured for operating in a wireless communication network 200 that may comprise a communication partner 25 of device 20. Communication may comprise exchanging a wireless signal 12, wherein the wireless signal 12 may be a signal transmitted as indicated for the wireless signal 12t or may be a received signal as indicated for the wireless signal 12r. Thus, exchanging a wireless signal relates to both transmission and reception of a wireless signal 12. The device 20 is configured for communicating with the communication partner 25 using a first carrier of the wireless communication network and for using a first set of beamforming weights that may be associated with the first carrier. The device 20 is configured for communicating with the communication partner using a second carrier of the wireless communication network 200 and using a different second set of beamforming weights which may be associated with the second carrier for exchanging a wireless signal.

That is, during a time in which carrier aggregation is not performed, the device 20 may be configured for communicating with the communication partner using the first carrier whilst not using the second carrier and to aggregate, at a later second instance of time when operating in carrier aggregation mode, the second carrier to the first carrier. For example, when using the first carrier, possibly as single carrier, the device 20 may use the first set of beamforming weights. When alternatively using the second carrier as single carrier, the device 20 may implement or use the second set of beamforming weights. Beyond this, the device 20 may be configured for aggregating the first carrier and the second carrier to enhance communication.

An antenna arrangement 14 of the device 20 may be configured for forming an antenna radiation pattern 16 based on an applied set of beamforming weights. The device 20 is configured for performing beamforming, i.e., to communicate using a beamforming technique to form a transmit beam pattern being a beam pattern selected from a plurality of transmit beam patterns being formable by the device. The device 20 may thus be configured for selecting one of the beam patterns from the plurality of beam patterns it may form and to apply corresponding weights to a beamforming network of the antenna arrangement so as to form the antenna radiation pattern. This may include obtaining weights from a database or look-up table or codebook but may also relate to calculate weights based on entries in such a codebook, wherein the codebook may be stored in a memory that is part of device 20 or another device.

In connection with some embodiments, the device 20 is configured for forming the antenna radiation pattern 16 as transmit beam pattern, i.e., as a radiation pattern for transmission purpose. Thereby, the device 20 may suffer from effects like the aberration illustrated in connection with FIGS. 1A-1C when forming the transmission beam pattern in more than one carrier as beamforming weights 19₁ or 19₂ that are used for controlling a beamforming network of the antenna arrangement 14 may be adapted or optimized to one of the used carriers whilst being less adapted or unadapted for the other carrier and might possibly result in suboptimal beamforming preciseness.

Although the antenna arrangement 14 is schematically drawn as a single antenna element, the definition of the antenna arrangement provided above applies, i.e., the antenna arrangement 14 may comprise a plurality of antenna elements, e.g., 2 or more, 4 or more, 8 or more, 16 or more or any other number. Although the antenna radiation pattern 16 is schematically drawn as comprising a single lobe, the antenna radiation pattern 16 may comprise at least one main lobe, at least one side lobe and at least one null arranged between adjacent lobes as may be seen, for example, in FIGS. 1A-C.

The device 20 comprises a control unit 18 configured for controlling the antenna arrangement 14, i.e., to apply beamforming weights and for providing signals to be transmitted or signals received with the antenna arrangement 14. That is, the control unit 18 is configured for controlling the antenna arrangement 14 so as to form the antenna radiation pattern 16 for transmission purpose or reception purpose.

The antenna arrangement 14 may thus be an antenna panel of the device 20 that is holistically controlled by the control unit 18 which is configured for supplying the selected set of beamforming weights to the antenna arrangement 14 so as to form the antenna radiation pattern being associated with the set of beams. That is, the antenna arrangement may be holistically controlled by a set of beamforming weights which may be selected or determined by the control unit 18. However, a selection of the beam pattern to be generated may be made by the control unit or by another entity of the wireless network, e.g., the communication partner 25, a control unit of another entity of the wireless communication network, e.g., a further node of the wireless communication network 200 or a network controller of the wireless communication network 200.

However, the device 20 may comprise at least a further, second antenna arrangement. Any number of antenna arrangements may be implemented in device 20. The selection of beam patterns may be done so as to select one beam pattern for each antenna radiation pattern. Each antenna arrangement may be provided with a beamforming network and a transceiver chain. That is, the device 20 may be configured for applying the set 24 of beamforming weights to a single beamforming network of the antenna arrangement 14.

The device 20 may be configured for implementing a variation in a carrier aggregation of carriers for further communicating with the communication partner. Such an action may form a trigger event leading to a new selection of the transmission beam pattern to be used. Varying the aggregation may relate to one or more of aggregating at least one carrier to a single carrier, e.g., a Secondary Component Carrier (SCC) to a Primary Component Carrier (PCC) or the like, to obtain an aggregation from a single-carrier communication; to increasing a number of carriers within the aggregation, e.g., from a number of x carriers to a number of y carriers with x, y>2, y>x; to decreasing the number of carriers, e.g., from a number of a carriers to a number of b carriers to arrive at a number of at least two carriers, e.g., with a, b>1, a>b; and/or to substituting a carrier of the aggregation by another carrier. Each of those cases may result in a changed behavior of the weights adapted for the selected beam pattern, e.g., in a specific carrier, at different carriers for which the same weights are used jointly.

The device 20 may re-select the beam pattern or the beam to be generated based on the variation in the aggregation. The re-selection may be done in view of an optimization criterion 26. The control unit 18 may have access to a memory that has stored the optimization criterion 26. For example, the memory may also have stored thereon beamforming weights 19₁ and 19₂ that allow to generate the radiation beam pattern 16 based on an identifier or the like received with the feedback information 22. Alternatively, the weights or parameters to derive weights may be stored in a different memory.

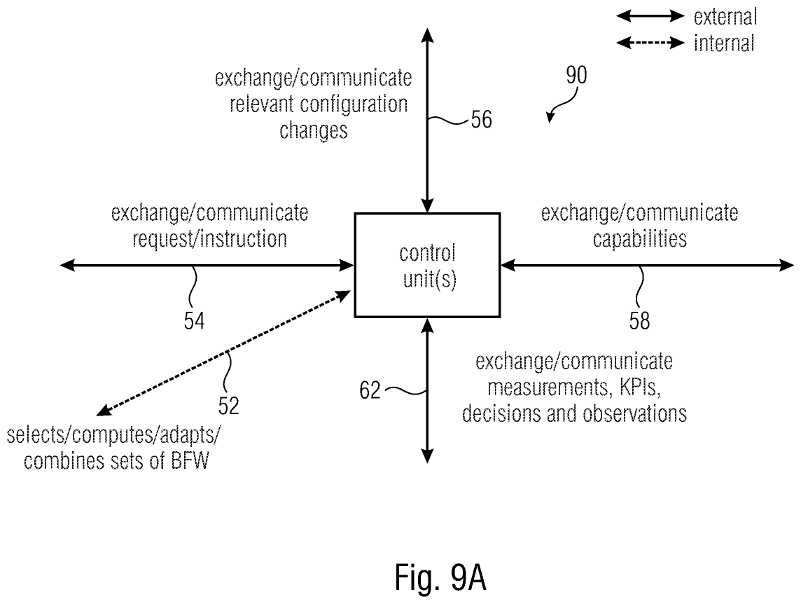

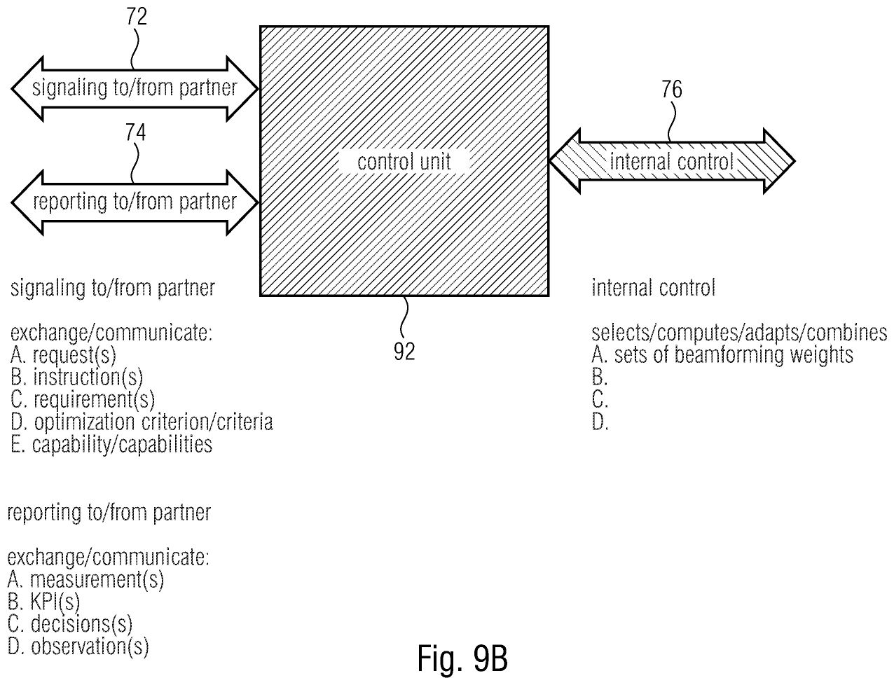

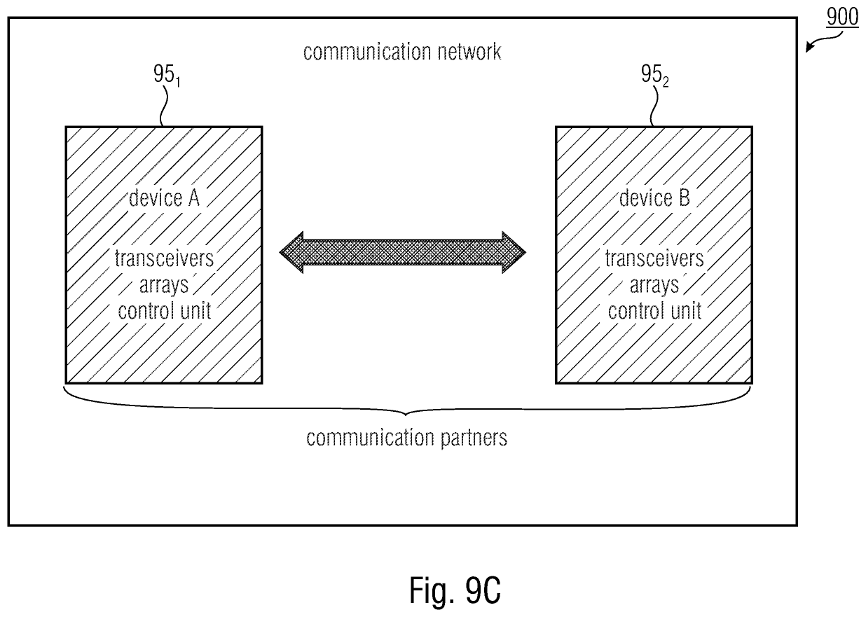

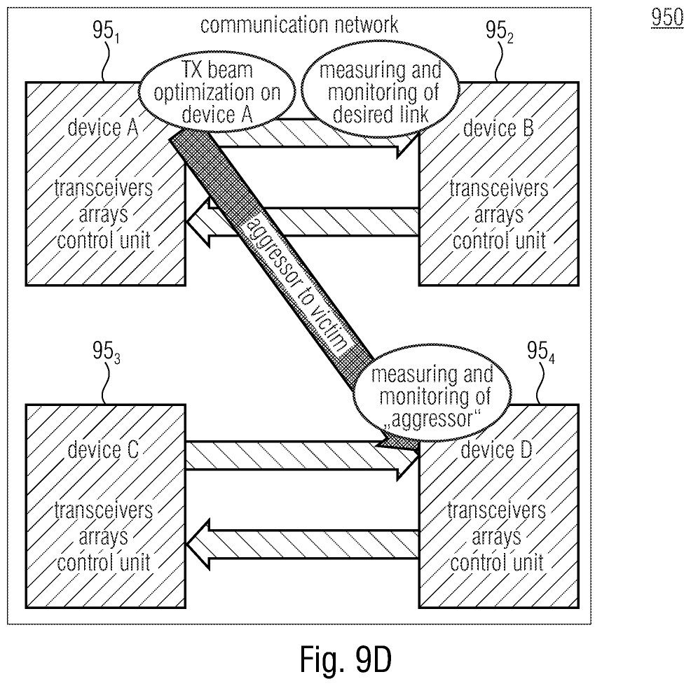

The optimization criterion may relate to the communication of the device 20 within the wireless communication network 200, e.g., the communication with the communication partner 25 which may include at least one metric measuring a parameter or quality of the communication between the device 20 and the communication partner 25. For example, the optimization criterion may include, alternatively or in addition, a metric or parameter that indicates an effect of the communication, in particular the transmit radiation pattern 16, with regards to other nodes part or not part of the wireless communication network 200 as illustrated in connection with FIG. 9D. The optimization criterion may, for example, relate to a layer 1 reference signal received power (L1-RSRP), a reference signal received quality (RSRQ), a signal plus interference to noise ratio (SINR), a link capacity indicator; a link throughput indicator; a link stability/resilience indicator; a field of view (FOV) indicator; and/or a combination thereof. According to an embodiment, the optimization criterion may relate to the communication with the communication partner and/or to interference caused at other entities of the wireless communication network.

The device 20 may be configured for receiving the feedback signal 22 from the wireless network, e.g., sent by the communication partner 25 or a different network entity. The feedback signal 22 may comprise instructions or information that relate to a decision made by at least one entity in the wireless communication network different from the device 20, to a suggestion for such a decision or indicating a parameter or measure that allows such a decision at the device. The decision may relate to a selection of a beam pattern to be generated and thus to a beamformer to be used. For example, responsive to a trigger event, the device 20 may generate a number of transmit beam patterns being at least a subset of the plurality of transmit beam patterns that the device 20 may generate such that the number of beam patterns is provided to the communication partner or a different entity of the wireless communication network. That is, the receiving entity may evaluate the generated beam pattern and may feedback information about the evaluation, said information indicated in the feedback signal 22. The feedback information 22 may relate, in general, to the beam patterns provided as the explained subset. The feedback information may indicate specific beams so as to match one or more criteria or to fail to do so but may, alternatively or in addition, refer to the effect of a swept beam e.g. SINR change etc. The feedback information may form at least a part of a basis for a decision, which transmission beam pattern to use for the aggregation. Said decision may be made at the device but also at another entity of the wireless communication network, e.g., a network controller or control unit of the network. The device 20 may implement a decision contained in the feedback signal 22, may make an own decision and/or may evaluate that a different beam pattern is to be used as selected beam pattern when compared to the decision in the feedback signal 22.

For example, the device may be configured for using the indicated beam pattern if no conflict is found during an evaluation of the feedback information; and/or for using the different beam pattern is a conflict is found during the evaluation.

The device may using e.g., by selecting on its own, following a selection stated in the feedback signal and/or refined by a further device-evaluation at least one of the provided number of beam patterns based on the feedback information as a selected beam pattern. Using the feedback information may relate to receiving an indicator relating to a decision already been made such that the result is indicated already in the feedback information 22. Alternatively or in addition, a metric or parameter may be contained in the feedback information and related to the provided beams such that the device 20 may make the decision based on evaluating the feedback information, e.g., in view of optimization criterion 26. Alternatively or in addition, the feedback information may indicate the decision already made and the device may be configured for decide whether to implement the decision or to deviate therefrom, e.g., when having additional information such as feedback information or interference information or performance information or the like from another device.

The received feedback information 22 may thus explicitly or implicitly indicate a beam pattern of the provided number of beam patterns, e.g., a beam pattern that is evaluated as being a best beam pattern or a most suitable beam pattern with regard to at least one metric which may be same or different from the optimization criterion. Alternatively or in addition, information that allows to derive such information may be contained.

The device may be configured for selecting the number of beam patterns to be provided or suggested based on an external decision (received instructions) and/or an internal own decisions. For example, when aggregating an SCC to a PCC, the device 20 may be implemented to generate the beam pattern that is associated with the PCC for the aggregation of PCC and SCC as one of the number of beam patterns and to generate the beam pattern that is associated with the SCC for the aggregation of PCC and SCC as another beam of the number of beam patterns. Such generated transmit beam patterns may thus be adapted to one single carrier of the aggregation. According to embodiments, at least one of the number of provided beam patterns is related to none of the carriers, i.e., is another, possibly independent transmission beam pattern. That is, the each transmit beam pattern of the number of provided beam patterns is adapted to at most one single carrier of the aggregation. The device may be configured for using the selected beam pattern for each carrier of the aggregation, i.e., jointly for the aggregation. This may allow to use the transmission beam pattern from the number of provided or suggested beam patterns that, within the boundaries of the optimization criterion, provides for the lowest errors, insufficiencies or degradations and may thus be considered as optimal. That is, the feedback information 22 may comprise information that indicates a best beam pattern amongst the provided number of beam patterns in view of the optimization criterion and/or comprises information indicating all beam patterns below (e.g. causing interference) or above (e.g. throughput gain) a given threshold. The evaluation may be done or provided by an entity external to the device 20, e.g., a communication partner or a different node which not even is needed to be part of the wireless communication network as long as it is able to transmit information to the device 20, e.g., directly, indirectly or via other nodes of the wireless communication network 200.

The feedback information 22 may thus indicated directly a transmission beam pattern selected by the feedbacking entity. Alternatively or in addition, the feedback information 22 may comprise information that indicates that the indicated beam pattern comprises a joint performance metric for the aggregation of carriers of above or below a predefined threshold for the communication partner and/or for a different entity of the network. Such information may allow deciding and/or ranking at the device 20 about which transmission beam pattern to use finally as selected beam pattern. As one may see, the selected transmission beam pattern is not necessarily a different beam pattern. It may be a same transmission beam pattern which is found to be still the optimum choice in view of the varied carrier aggregation.

The device may be configured for establishing communication with the communication partner using a first carrier and a first transmit beam pattern, i.e., a single carrier and an associated transmission beam pattern, e.g., a PCC. The device may then aggregate a second carrier to the first carrier to obtain one variant of a trigger event; and for selecting the transmit beam pattern and for using the selected transmit beam pattern jointly or commonly for the aggregation of carriers. The device may be configured for further selecting the transmit beam pattern without variation in the aggregation of carriers based on the trigger event.

Based on the decision, which transmission beam pattern to use, the device 20 may derive, e.g., by using a codebook, a table, a determination rule together with computational power and/or received values, beamforming weights to be applied to the antenna arrangement 14. Those beamforming weights may be referred to as joint beamforming weights as they are used for the aggregation in total instead as for a single carrier only.

The instructions may comprise a boundary condition, e.g., which conditions the radiation beam pattern generated with the joint set 24 of beamforming weights should fit (e.g., direction, gain, number of multipath components, LoS-path, nLoS-path, . . . ) or may comprise more concrete information that allow to derive the joint set 24. That is, the beamformer to be used may be decided or chosen by the network or may such a decision may at least be assisted by the network. In other words, the decision on the beamformer finally to be chosen from a set of beamformers is done by or assisted by the other end of the communication link, the network, e.g., a base station or by a higher entity such as a network controller.

According to embodiments for implementation reasons, the beamformer may be selected by the entity differing from the device 20, whilst the associated beamforming weights are to be selected by the device 20. According to an embodiment, the selection of the beamforming weights may also be done by the other entity or entities outside of the device. For example, when the device 20 is configured for implementing hybrid beamforming and subarrays of the antenna arrangement 14 are marked with reference signals (RS) such as pilots using a codebook allowing the receiver to calculate another code book entry or precoder, and instruct/feedback to the transmitter that a specific beam pattern with associated values/weights are to be applied/chosen at the device 20. However, the weights do not have to be calculated or transmitted by the other entity as they may be known for the control unit 18 that is implemented to select or determine the weights to be applied based on the indication which beam to generate.

In connection with embodiments, the device 20 is configured for operating in the wireless communication network 200 and for performing communication with a communication partner within the wireless communication network by exchanging a wireless signal; wherein the device is configured for communicating with the communication partner 25 using a beamforming technique to form a transmit beam pattern being a beam pattern selected from a plurality of transmit beam patterns being formable by the device 20. The device 20 is configured for providing, responsive to a trigger event, a number of transmit beam patterns being at least a subset of the plurality of formable transmit beam patterns to the communication partner or a different entity of the wireless communication network. The device is configured for receiving feedback information relating to the beam patterns of the number of beam patterns. The device is configured for using at least one of the provided number of beam patterns based on the feedback information as a selected beam pattern. Using may relate to selecting on its own, following a selection stated in the feedback signal or implementing a refinement of the selection indicated in the feedback information 22 and made by a further device. The device is configured for using an aggregation of carriers for the communication; The device comprises an antenna arrangement and a control unit configured for controlling the antenna arrangement for selecting or re-selecting and forming the selected transmit beam pattern for the aggregation of carriers.

FIG. 2B shows a schematic block diagram of the wireless communication network 200 illustrating the device 20 providing a first transmission beam pattern 16₁ based on beamforming weights 19₁ during a first instance of time and providing a second transmission beam pattern 16₂ based on beamforming weights 19₂ during a second instance of time which is disjoint to the first instance of time. For example, device 20 has established communication with the communication partner 25 using a first carrier and a beam pattern that is based on the set of beamforming weights 19₁ in the first carrier. Further, the device 20 may The feedback information 22 may indicate that the evaluating communication partner 25 considers transmission beam pattern 16₂ as the best option within the suggested transmission beam patterns.

FIG. 2C shows a schematic block diagram of the wireless communication network 200 illustrating the device 20 providing the transmission beam pattern 16₂ as the selected beam-pattern. The device may be configured for selecting, based on the feedback information 22, the at least one selected beam pattern 16₂ by considering the optimization criterion 26 relating to the communication within the wireless communication network, e.g., for direct communication and/or for overall communication in the network. However, the optimization criterion may be not needed in device 20 when same executes a decision that may be contained in the feedback signal 22 and which may be made by another entity. That is, the evaluation criterion may be evaluated or considered at device 20 and/or at another entity of the wireless communication network.

That is, the control unit 18 may be configured for receiving the information indicating the joint set 24 of beamforming weights by receiving information containing the joint set 24 of beamforming weights and/or by receiving information indicating a plurality of sets of beamforming weights, wherein, for that case, the control unit 18 may be configured for selecting the joint set 24 of beamforming weights from the indicated plurality of sets or to calculate the joint set 24 of beamforming weights based on the indicated plurality of sets. That is, the signal 22 may indicate the boundary conditions for determining the joint set 24.

Alternatively or in addition, in a different operating mode, the device 20 may be configured for determining the joint set 24 on its own. It is to be noted that the sets 19i and 19₂ and the optimization criterion 26 may be stored in same or different memories and/or same or different memory areas. The control unit 18 may be configured for determining, using the optimization criterion 26, the joint set 24 of beamforming weights by using or combining the sets 19₁ and 19₂. That is, when determining the joint set 24 of beamforming weights autonomously or on its own, the device 20 may calculate/select the joint set 24 based on the setting it would use for using the single first carrier or the single second carrier in view of the optimization criterion 26.

The optimization criterion 26 may comprise any suitable metric to be optimized within the wireless communication network 200. For example, the optimization criterion 26 may comprise a monitored signal quality metric on the relevant reference signals. For example, the signal quality metric may comprise at least one of a layer 1 reference signal received power (L1-RSRP), a reference signal received quality (RSRQ), a signal plus interference to noise ratio (SINR) or a combination thereof, whilst not excluding other or further criterions that allow to increase network throughput. When receiving the joint set 24 or information indicating the set with the signal 22, the calculation of the joint set 24 may be performed at a network-side, therefore allowing to reduce the computational power at the device 20.

For example, the device 20 may indicate, to the network 200, its capability to perform carrier aggregation and beamforming and may report at least part of its current channel situation that is used to determine the joint set 24 of beamforming weights. Responding hereto, the network 200 may provide the device 20 with a selected beamformer by e.g. indicating a beamformer index and/or the joint set 24 of beamforming weights. For example, the device 20 may be configured for transmitting a capability signal 28 to the wireless communication network 200, the capability signal 28 indicating that the device 20 is capable for using the joint set of beamforming weights commonly for at least two carriers. The capability signal 28 may be transmitted with the antenna arrangement 14 or may be transmitted wired or wirelessly with a different interface. Same is true for the signal 22 that may be received with any wired or wireless interface, amongst them the antenna arrangement 14.

According to embodiments, a device is configured for transmitting, to an entity of the wireless communication network a capability information indicating a capability of the device to perform carrier aggregation and a capability to perform beamforming for the communication and/or receiving such capability information relating to another device. Such an implementation may be in accordance with providing the transmit beam patterns and implementing a selection from the provided subset but may also be implemented separately, as an independent embodiment.

For example, the device may be configured for transmitting the capability information so as to indicate a number of antenna arrays or antenna panels used for communication; a number of radio antenna patterns generatable by the device and to whether carrier aggregation is supported, e.g., by indicating a number of aggregatable carriers; or is unsupported. For example, capabilities may relate to one or more of a combination of antenna arrangements, transceiver chains, beam forming networks and number of streams and/or carriers.

The capability information, the signal 28 respectively may relate to at least one of:
a number of spatial streams to be supported simultaneously;
a number of antenna arrangements/panels used simultaneously for transmission;
a number of carriers to be mapped per spatial beam simultaneously;
a number of carriers to be mapped per antenna arrangements/panel simultaneously;
a number of transceiver chains connecting the antenna port control/distribution unit with the beam forming networks and/or antenna arrangements/panels;
supported mapping options between carriers, spatial beams and/or antenna arrangement/panels;
support of MIMO on multiple carriers with independent beamforming weights per carrier or dependencies in beamforming for beamforming on multiple carriers;
a number of beamformers to be provided if requested to;
thresholds for beam reselection procedure to be triggered;
a metric describing the dependency of beam (main lobe, side lobe, nulls) deviations vs. carrier distance in spectrum, relative direction of main lobe to the antenna arrangement;
a maximum number of carriers to be operated simultaneously via the same panel/beam forming network; and
a maximum spectral distance between two or more carriers to be simultaneously operated via the same panel/beam forming network.

That is, e.g. if two panels are available and active at the same time: if the device is capable of mapping one carrier onto one panel only or can the device map multiple carriers on each panel simultaneously.

Although the representation of device 20 and the communication partner 25 may be interpreted as representing a handheld device, for example, a user equipment (UE) or a customer premises equipment (CPE), the device 20 may also be adapted to operate as a base station, another terminal in side link operation, a relay node of the wireless communication network, an integrated access and backhaul (IAB) node or a customer premises equipment (CPE) of the wireless communication network.

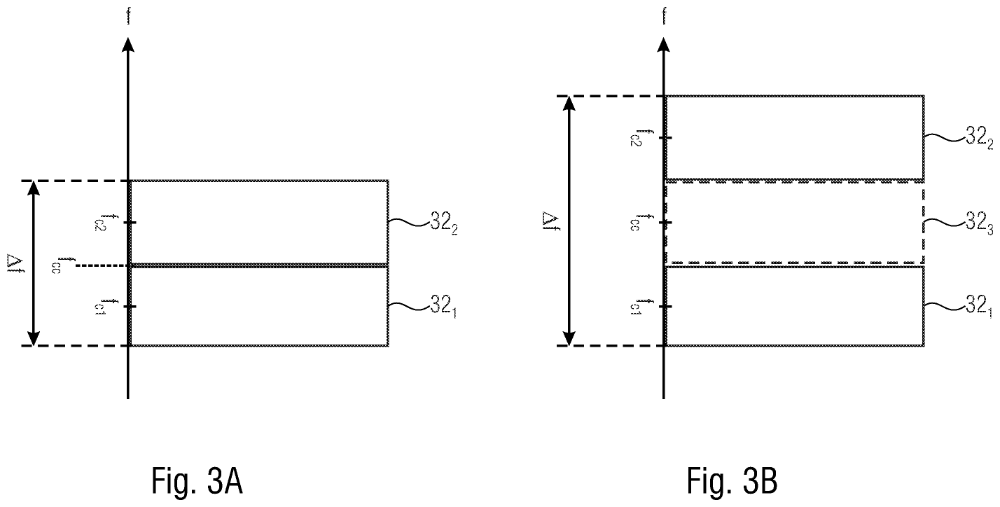

FIG. 3A shows a schematic representation of two carriers 32₁ and 32₂ arranged adjacent to each other in frequency. The carriers 32₁ and 32₂ may be used, optionally together with further additional carriers in the wireless communication network 200. The device 20 may be configured for aggregating the carriers 32₁ and 32₂ for using them as a combinatory or joint carrier. Center frequencies f_{c1} of carrier 32₁ and f_{c2} of carrier 32₂ that may possibly be used for determining beamforming weights when using either the carrier 32₁ or the carrier 32₂ may thus become, at least in parts, invalid in view of a new combinatory or joint center frequency f_{cc} which is at least partly compensated for by determining the joint set of beamforming weights.

FIG. 3B shows a schematic representation of the carriers 32₁ and 32₂ of FIG. 3A being arranged to each other non-adjacently, for example, being spaced from each other by at least a third carrier 32₃ being currently unused for the communication of the device 20. However, by aggregating the carriers 32₁ and 32₂, the combinatory center frequency f_{cc} may be a frequency that possibly lies within the further carrier 32₃ which illustrates the basis of possible errors by combining carrier aggregation and beamforming. In FIG. 3B it may further be seen that the total frequency range spanned by the aggregated carriers may become very large and may, additionally, be based on a number of carriers being arranged between the aggregated carriers. By determining or at least using the joint set 24 of beamforming weights being adapted in view of an optimization criterion, such drawbacks may be compensated. It should be noted that the underlying cause of frequency dependency of the direction of radiation pattern/main lobe/side lobe/null direction is the fact that the phase and attenuation ratios between the multiple antenna elements used for beamforming have to be matched to the wavelength of the electromagnetic wave to be beamformed. If the occupied bandwidth of the modulated RF signal is in the order of 1/10.000 of the RF carrier frequency and the direction of transmission and/reception close to boresight of the antenna array, then the frequency dependency is tolerable in terms of angular perturbance across the entire spectrum used for transmission/reception. If the allocated/occupied bandwidth of aggregated carriers is in the order of e.g. 1 or a few GHz at a RF carrier of about 28 GHz then the frequency dependency may become significant in terms of performance (throughput, interference etc.).

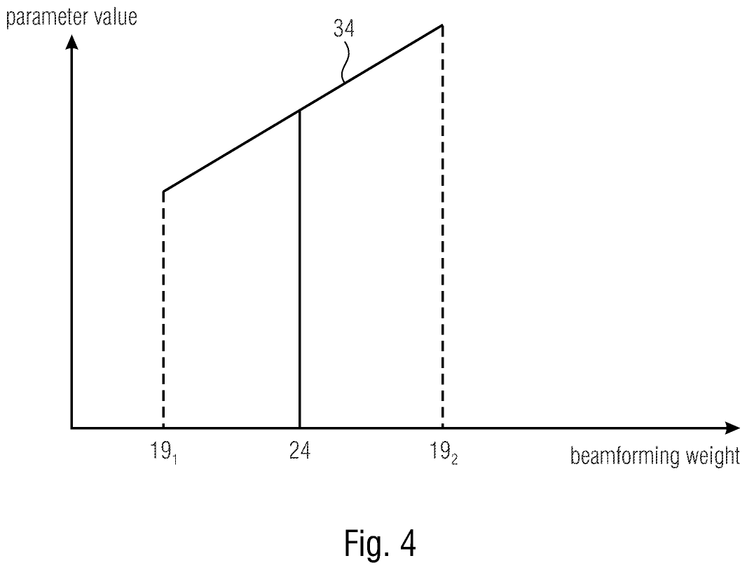

FIG. 4 shows a schematic diagram of different beamforming weights 19₁, 19₂ and 24 being represented by parameter values (ordinate). However, it may be understood that beamforming weights may be provided or used as a set, thus providing for a plurality of single parameter values. The values may have any dimension, e.g., being based on the requirements of the control unit 18 and/or the beamforming network and/or the antenna arrangement 14. Alternatively or in combination with the fixed set of beam forming weights the individual beam forming weights may be obtained by an algorithm individually or in subset of the overall values in an iterative manner e.g. brute forced or trajectory based selection supported or not supported by AI for faster convergence, stability and/or optimality.

For example, in view of the carrier aggregation being described in connection with FIG. 3A and FIG. 3B, the control unit 18 may have knowledge about the set 19₁ and the set 19₂. By combining the set 19₁ and the set 19₂, e.g., using a function 34 or any other determination rule which may be influenced by the optimization criterion, the control unit 18 or the network may determine the joint set 24 of beamforming weights. The determination rule 34 may comprise a linear and/or non-linear function and may consider 1, 2 or a higher number of different parameters and/or boundary conditions. Optionally, only one of the sets 19₁ and 19₂ may be used as an input value for the determination rule 34 which does not exclude additional input values.

When considering the device and in particular the control unit as being configured for determining the joint set 24 of beamforming weights, the control unit 18 may also be configured for selecting either the first set of beamforming weights 19₁ or the second set of beamforming weights 19₂ as the joint set 24 of beamforming weights. That is, the joint set 24 is not needed to deviate from both sets 19₁ and 19₂, wherein the decision of which set to be used is based on the optimization criterion.

For example, the control unit 18 may compare whether a use of the first set for the aggregated carriers or a use of the second set for the aggregated carriers is more promising in view of the optimization criterion.

The control unit 18 may be configured for selecting, from a plurality of sets of beamforming weights, e.g., a large number such as all sets or at least the sets that are related to a current direction to be implemented, the first set of beamforming weights for use for the first carrier and for selecting, from the plurality of sets of beamforming weights, the second set of beamforming weights for a use for the second carrier of wireless communication network and associated to the selected antenna radiation pattern. The control unit 18 may be configured for selecting, based on the optimization criterion, one of the first set 19₁ of beamforming weights and the second set 19₂ of beamforming weights and for applying the selected set of beamforming weights for an aggregation of both, the first carrier and the second carrier to exchange the signal.

The control unit 18 may be configured for selecting the joint set 24 of beamforming weights based on a comparison of an effect, in view of the optimization criterion, on an obtained carrier aggregation comprising the carriers 32₁ and 32₂, and optionally additional carriers when selecting the first set 19₁ of beamforming weights on the one hand, and when selecting the second set 19₂ of beamforming weights on the other hand. The one with the better effect may be selected.

Besides selecting one of the sets for a use for the aggregation, the control unit 18 may be configured for determining or calculating the joint set 24 of beamforming weights as a modification of at least one of the first set 19₁ of beamforming weights and the second set of 19₂ of beamforming weights.

One practical way of determining the joint set 24 and/or to provide the beam patterns for the selection at the other entity may be implemented by use of a beam adjustment, for example, by performing a beam sweeping and/or a technique to iteratively narrow the beam whilst considering a direction along which a direction of the beam is obtained and maintained. For example, the device may be configured for providing the number of transmission beam patterns based on a beam sweeping of a specific transmission beam pattern. For example, the device may be configured for receiving the feedback information 22 indicating the specific beam/beam pattern, wherein the device may be configured for receiving a first transmission-beam sweeping request from the network, and for performing a transmission-beam sweeping process responsive to the first transmission-beam sweeping request using the specific beam pattern; and for receiving a second transmission-beam sweeping request from the network and for performing a transmission-beam sweeping for a transmission beam pattern indicated in the second request responsive to the second transmission-beam sweeping request. A beam sweeping process may be executed by the device as one option for providing patterns, alternatively a device can offer a number of alternative beams, e.g. marked with IDs like Sounding Reference Symbols (SRS), Synchronization Signal Block (SSB), Chanel state information reference signals (CSI-RS) to be referred to. Sweeping may be understood of creating beams one after the other which are in proximity or even overlapping. That is providing may comprise generating similar beams in view of a sweep and/or beams differing from each other to a higher degree.

As described in connection with FIG. 4, the control unit 18 may be configured for determining the joint set 24 of beamforming weights by combining the sets 19₁ and 19₂ according to the determination rule 34 so as to calculate the joint set of beamforming weights. According to embodiments, however, the control unit may be configured for selecting one of the sets 19₁ and 19₂ as the joint set. According to an embodiment, either based on a different implementation of the device 20 or based on a different scenario, instead of selecting one of sets 19₁ and 19₂, a third set of beamforming weights may be chosen/calculated which performs better according to a particular metric when both carriers are taken into account instead of just one carrier alone, e.g., the PCC. The device may be configured for selecting the transmit beam pattern based on a continuous frequency range Δf being spanned by a lowest frequency and a highest frequency of carriers 32₁ and 32₂ being aggregated, i.e., a lowest and a highest frequency of the obtained aggregation.

The device 20 may be configured for determining the joint set 24 of beamforming weights and for receiving information from the wireless communication network to select a joint set 24 of beamforming weights from a number of sets or to calculate the joint set of beamforming weights. That is, the device 20 may receive a signal that instructs the device 20 to operate according to embodiments, e.g., together with instructing the device 20 to perform carrier aggregation and/or beamforming. Such instructions may alternatively or in addition contain boundary conditions to be considered, e.g., beam patterns to be used for a selection and/or to be excluded from such a selection.

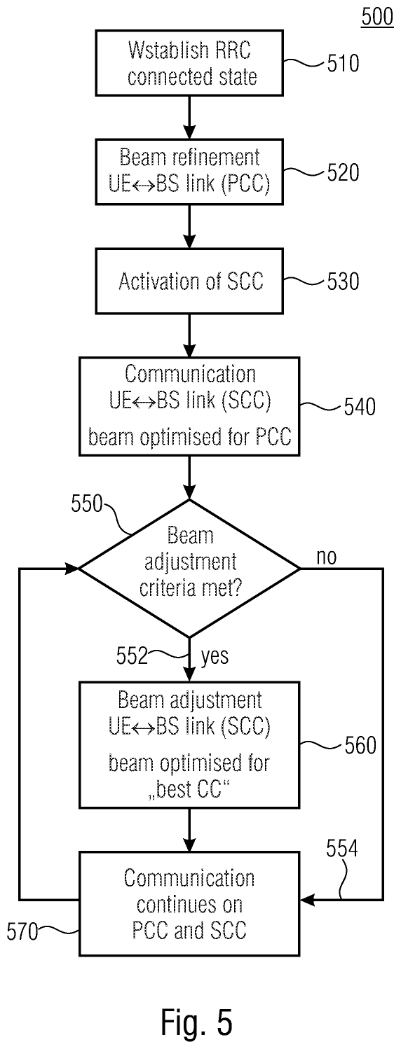

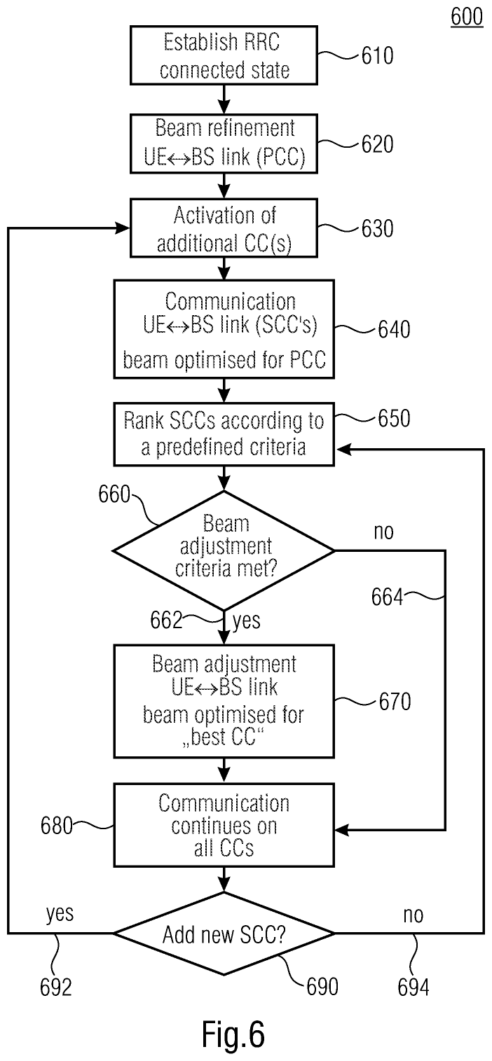

FIG. 5 shows a schematic flowchart of a method 500 according to an embodiment which may be executed or implemented, at least in parts, by the device 20. Method 500 in particular relates to an aggregation of two carriers whilst method 600 described in connection with FIG. 6 addresses an aggregation of at least three carriers.

A step 510 of method 500 comprises establishing RRC (radio resource control) connected state, i.e., establishing a connection to the communication partner, e.g., a base station/gNB, a UE, a relay or the like, which may comprise execution of a beam adjustment process.

A step 520 comprises execution of a beam refinement process for the connection which is referred to as, by way of non-limiting example only, as a UE-BS link on a primary component carrier PCC. The PCC may be, for example, carrier 32₁ or 32₂. The link may be used in the direction from the UE to the BS and/or from the BS to the UE, i.e., from one of the devices to the other or bidirectional.

A step 530 comprises activation of a secondary component carrier SCC, e.g., the other carrier 32₂ or 32₁. For example, based on instructions or based on a request, another carrier may be assigned or occupied for communication. That is, carrier aggregation may be established which may comprise adding and/or activating SCC.

When having activated SCC, the communication between the UE and the base station and the used link (or the device 20 and its communication partner 25) in the SCC may be using the same beamforming weights which are optimized for the PCC as illustrated in step 540.

A step 550 of method 500 comprises a determination if an beam adjustment criteria is met. For example, the PCC and/or the SCC and/or the aggregation or a different criteria may be evaluated if a trigger condition is met that leads to beam adjustment. For example, it may be determined by the network or by the device 20 if the PCC, the SCC or for the aggregation, other or modified beamforming weights associated therewith are more suitable for the combination using the aggregation of PCC and SCC. If the decision is “yes”, the flowchart may follow a path 552 towards a step 560 in which a beam adjustment for the used link is adapted to the SCC in the first iteration, to a different, previously determined optimum if re-executed, therefore arriving at a beam that is optimized for the best CC which might be identified to be the SCC. In a step 570 communication may continue on PCC and SCC in a combined, aggregated manner. If the decision in step 550 results in “no”, a path 554 may lead towards step 570 resulting in a use of PCC weights in step 570. For example, it may be the networks decision that leads the network to instruct the UE to switch to a SCC, see step 550, but the UE may know which beamforming weights are used for PCC and which for SCC.

Method 500 is illustrated in connection with selecting one of the PCC weights or the SCC weights for communication. Steps 550 and 560 may also be executed so as to determine the best set of weights by computing or calculating the joint set 24 of beamforming weights.

Method 500 may be understood as being executable when obtaining the aggregation. That is, the device may be implemented such that the control unit is configured for determining the joint set of beamforming weights based on the event of aggregating the second carrier However, from time to time or at least one additional time, the already obtained optimum may be verified or newly determined, e.g., to compensate for changes in the channel conditions. Such a device may be implemented that the control unit is configured for determining the joint set of beamforming weights based on a trigger event to update the joint set of beamforming weights, i.e., the joint set may be determined iteratively or repeatedly determining the set of joint beamforming weights.

The trigger event may be related to at least one of
a timer;
a counter;
a fixed or adaptive periodicity;
a determined change in a channel condition between the device and the communication partner;
a change in the optimization criterion;
a report about interference experienced by a device responsive to the used beam pattern;
a change in an antenna arrangement of the device used for communication;
a change of relative or absolute directivity angle between the device and the communication partner or other devices affected by the aggregated communication links;
a variation in the carrier aggregation;
instructions received from an entity of the wireless communication network which may include a request that a certain digital beamforming code book is requested to be chosen;
inter carrier frequency separation frequency being beyond a predetermined threshold;
a variability of the channel exceeds a threshold; and
a combination thereof.

The variation in the carrier aggregation may comprise at least one of:
aggregating at least one carrier to a single carrier to obtain the aggregation;
increasing a number of carriers within the aggregation;
decreasing the number of carriers to at least two carriers;
substituting a carrier of the aggregation by another carrier; and
increasing/decreasing/substituting the number of aggregated carriers of another wireless communication link in proximity/range of the device, which may refer to other coexisting links in the same band or adjacent band which might be affected by interference or may cause interference;
a combination thereof.

The device may be configured for iteratively update the set of beamforming weights so as to evaluate alternative options for the joint set of beamforming weights. That is, the device may try, evaluate or determine, if a different set of beamforming weights and thus a different beam is more suitable, in view of the optimization criterion, for the communication with the communication partner. This includes that the optimization criterion may change, e.g., from a highest throughput to a lowest latency or to any other local or overall measures within the wireless network.

FIG. 6 shows a schematic flowchart of a method 600 in which the device 20 is configured for carrier aggregation by use of the first carrier, the second carrier and at least a third carrier. A step 610 may comprise establishing an RRC connected state as described for step 510. A step 620 may comprise a beam refinement/beam correspondence process for the UE-BS link on PCC as described for step 520.

A step 630 may comprise activation and/or aggregation of one or more additional CCs. For example, when only aggregating one further component carrier being an SCC, step 630 may at least in parts correspond to step 530. However, step 630 allows for aggregating one or more CCs.

Step 640 comprises a communication in the obtained link UE-BS (UE->BS; UE<-BS or UE<->BS; wherein UE and BS are non-limiting examples as in FIG. 5) using a beam that is optimized for PCC as described in connection with step 540.

A step 650 may comprise ranking the CCs and/or SCCs according to a predefined criterion which may at least in parts correspond to the optimization criterion. The result of the ranking may be an identified best carrier and/or a list of carriers having the aggregated carriers or a subset thereof in a ranked order. A step 660 comprises a decision whether the first ordered adjustment criterion is already met, e.g., in view of the ranked or first ordered CC. That is, a decision may be made whether a carrier different from PCC fits better than PCC or which CC fits best. If the decision is answered with “yes”, a path 662 may lead to a step 670 in which the beam adjustment for the UE-BS link is adjusted according to the first ranked SCC such that the beam is optimized for the identified best component carrier. A step 680 performed after step 670 thus allows for a communication to continue on all component carriers with the setting of step 670. If the decision of step 660 is answered with “no”, a path 664 may lead toward step 680 resulting in the communication to continue on all CCs by the use of the setting used for the PCC.

Optionally, a step 690 comprises to add a new SCC. The step 690 may be implemented as a decision. If the decision is answered with “yes”, a path 692 may allow to jump back in method 600, e.g., to method 630 to an aggregation or activation of the additional carrier or the additional carriers. Then, optimization may be performed, again, for the newly obtained aggregation. If the decision 690 is answered with “no”, a path 694 may lead back to step 650 allowing to rank again the carriers of the aggregation. For example, path 694 may be followed, executed or the iteration to optimize or rank again the carriers may be triggered based on a timer, a counter, a detected change in the channel condition or the like.

As was described in connection with FIG. 5, method 600 relates to iteratively aggregating carriers to the first carrier and for iteratively obtaining the joint set 24 of beamforming weights for the aggregated carriers. Again, method 600 is related to deciding for specific sets from the sets associated with the aggregated component carriers. However, according to embodiments, the joint set 24 of beamforming weights may be determined or calculated as a set that deviates from those sets as was described, for example, in connection with FIG. 4.

Both ways, determining the joint set 24 of beamforming weights by selecting from the associated sets or by calculating the new values allows for evaluating the aggregation being obtained by aggregating the carriers so as to obtain the joint set of beamforming weights.

Although method 600 allows to iteratively obtain the joint set 24 of beamforming weights, e.g., when aggregating only one additional CC in step 630, embodiments are not limited hereto. For example, when aggregating more than one additional CC in step 630, the computation or calculation of the joint set 24 of beamforming weights may also be performed non-iteratively. As described in connection with step 560 and 670, the device 20 may be configured for aggregating the carriers to an aggregation, for obtaining information indicating a carrier of the aggregation as selected carrier and for performing a beam adjustment procedure for the aggregation based on the selected carrier.

The transmit beam (re-)selection, as a result, may be performed based on a device-based decision and/or based on a network-based decision.

As was described for FIG. 5, method 600 may be executed repeatedly or iteratively so as to adapt the beamforming weights even if no modification in the carrier aggregation is implemented. Method 600 and other embodiments may alternatively or in addition be executed when reducing the number of carriers and/or when substituting a carrier by another. That es, in general, when changing the carrier aggregation, an optimized joint set of beamforming weights may be determined for the updated carrier aggregation.

In other words, whilst FIG. 5 shows an overview of a proposed PCC/SCC beam adjustment procedure, FIG. 6 shows the procedure used for more than two component carriers by way of an example when ranking of SCCs is performed. Embodiments relate to first rank the second, third and optionally additional SCC and then apply the same evaluation and selection criteria as in the case of two carriers. That is, the best SCC may be selected and may then be compared against the PCC.

In other words, methods according to embodiments may comprise one or more of the following steps. Devices in accordance with embodiments are implemented to execute such methods at least in parts. The steps may be formulated, for example, as:
1. Establish RRC-connected state between BTS and UE-PCC.
   1.a. At any point during the active connection, e.g. UE in RRC_CONNECTED, BTS can request (additional) UE radio access capability information. The UE responds with the capability information. Relevant to this invention is the UE capability info that would indicate support for, transmit beam adjustment, which could also include additional parameters, such as number of antenna panels, maximum number of supported beams etc.

| | | |
|---|---|---|
| CA-ParametersNR ::= | SEQUENCE { | |
| CA-beamReselection | ENUMERATED {supported} | OPTIONAL, |
| SEQUENCE{ | | |
| multiplePanels | BOOLEAN, | |
| maxNumberOfBeams | INTEGER (1,...N) | |
| } | | |
| ... | | |
| } | | |

2. Establish carrier aggregation—add and activate SCC.
3. Either network or a UE may determine (by computation) that SCC is somehow “better” than PCC. For example, the network entity may determine (by computation) that it can allocate a greater bandwidth to the UE on SCC or the UE can receive a feedback from the network that it has a better L1-RSRP/RSRQ/SINR or any other monitored signal quality metric on SCC measured on the Sounding Reference Signal (SRS), demodulation reference signals (DM-RS) or any other relevant uplink reference signal.
4. Therefore, either automatically or based on a decision resulting from a defined set of conditions, the UE or the network entity decide that the frequency range of operation associated with the SCC (rather than the PCC) should be used to select or determine by computation the appropriate set or sets of beamforming weights for the transmission.
5. Perform UE Tx beam adjustment/reselection
   a. UE-based decision
      The UE may be pre-configured/configured (according to the system specifications) with a condition or a set of conditions that will trigger Tx beam reselection optimized according to the specified criteria. An example of the condition could be the case when the feedback information from the network is received, indicating to the UE performance indicators from both carriers. The network may be configured, according to the system specification, to issue such an indication when the adopted signal quality metric hysteresis on gNB (receive side) SCC compared to PCC using the adopted metric, i.e. L1-RSRP/RSRQ/SINR on SRS, demodulation reference signals or any other relevant reference uplink signal, exceeds/falls below a predefined threshold. Once the condition is met, the UE can, for a given gNB RX beam on SCC: i) switch to the best Tx beam, provided before; or ii) initiate the TX beam provisioning/sweeping procedure and compute/select combinatory set/joint set of beamforming weights, according to some predefined criteria. Note that if beam correspondence holds, the beam used for downlink reception is assumed to be suitable for the uplink transmission. Considering that this is a UE-based decision, the UE should also inform the base station about the beam adjustment/reselection, using uplink control information/channel. For example, an indication of the PCC/SCC beam selection or the optimized beam index can be multiplexed within the Channel State Information (CSI) report.
      b) Network-based decision
      The base station may decide after performing measurements on a set of provided UE TX beams, and based on a certain condition or a set of conditions, such as the received signal quality metric, such as L1-RSRP/RSRQ/SINR on SRS, demodulation reference signals or any other relevant reference uplink signal on PCC and SCC, or based on the available bandwidth on component carriers to request the UE to perform TX beam adjustment/reselection. For this, the base station can use the combination of RRC signaling and/or MAC Control Elements and/or Downlink Control Information. The UE can then, for a given gNB RX beam: i) switch to the indicated Tx beam; or ii) initiate the TX beam reselection/sweeping procedure and compute combinatory set/joint set of beamforming weights, according to the signaled criteria. If beam correspondence holds, the UE can consider using the beam requested and furthermore, the Tx beam corresponding to the best RX beam used for downlink reception.
6. Continue communication on both carriers where UE uses a joint beam optimized to the best CC or other predefined criteria

When referring again to FIGS. 2A-C showing an example wireless communication network, same may comprising at least one device 20 but also any number of such devices. The wireless communication network may comprising a control unit configured for re-selecting the beam pattern based on the optimization criterion, such a control unit may be implemented at one or more entities and may provide for the decision and/or measure relating to the provided beams so as to provide for a basis of the feedback signal 22. The control unit may thus be the control unit of the device or of a different entity of the wireless communication network.

The device and the communication partner may be configured for jointly performing a beam management process or a beam adjustment process in an autonomous manner or orchestrated by a network entity for re-selecting the beam pattern.

The device and the communication partner may be configured for using a same or different metrics for transmit beam selection during the beam management process or the beam adjustment process.

The wireless communication network may be configured for considering an optimization criterion relating to the communication with the communication partner and/or a different device, i.e., for direct communication and/or for overall communication in the network.

Embodiments provide for devices and methods that allow to establish a link on PCC, including a selection of beamformers in either direction from the device e.g., in direction towards the communication partner. Carrier Aggregation may be initiated using a SCC. At that stage, the beamforming may still be optimized for the PCC. The Carrier Aggregation may trigger performing a procedure allowing that at least one device or entity probes the effect of other/different joint beamforming weights on the performance of PCC (CC1) and SCC (CC2) and a joint performance according to a particular criterion metric. The device receiving the transmission beam patterns may provide performance feedback, signal 22, to the transmitting device to allow to make a decision on a best or new joint beam for the carriers. The decision about the TX beam used at the transmitting device may be made by the receiving device and communicated by feedback about e.g., beam index, describing the request to use a specific transmission beam pattern jointly for the aggregation at the transmitting device.

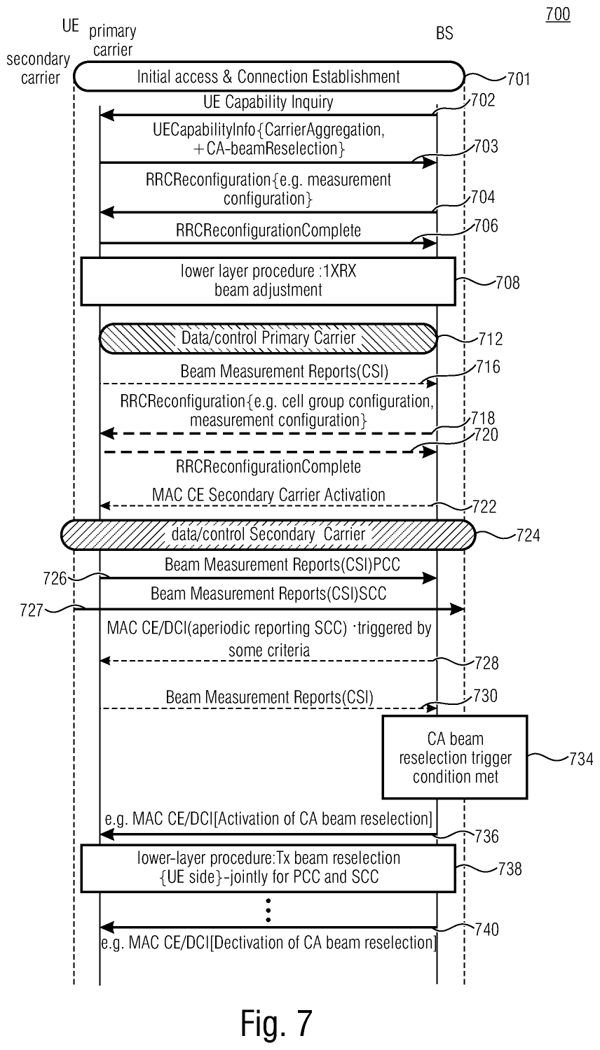

FIG. 7 shows a schematic flow chart of a method 700 illustrated by an exchange of signals or messages between a UE, e.g., device 20, and its communication partner, e.g., a base station BS. At 701, a lower layer procedure is executed to obtain an initial access and connection establishment. In 702, the base station may transmit capability information inquiry to device. In 703, the UE may signal the communication partner and/or the base station, informing them of, e.g. Carrier Aggregation capability and the capability to perform TX beam reselection, e.g., using signal 28. At 704, the communication partner informs the device 20 that an RRC reconfiguration is scheduled, for example, responsive to a measurement configuration. In 706, the UE may inform the base station that RRC reconfiguration is complete. In 708 a lower layer procedure may be executed to perform beam adjustment between Tx and Rx beams on both ends of the communication link. Communication may thus be established in a primary carrier for exchanging data and/or control signals, 712. For example, at 716, the UE may report about beam measurement results, for example, channel state information (CSI). RRC reconfiguration may be requested by the communication partner by transmitting a respective signal, for example, based on a cell group configuration and/or a measurement configuration, 718.

At 720, the UE may inform the base station that RRC reconfiguration is complete. At 722, the communication partner or a different entity, e.g., the base station may instruct the device 20 activate an additional carrier so as to activate or aggregate a secondary carrier for data and/or control signals in 724. At 726/727, the UE may report about beam measurement results, for example, channel state information (CSI). An aperiodic or periodic reporting for both carriers may be requested in 728 which may result in additional beam measurement reports on both carriers, using CSI, 730. In 734, it may be evaluated whether a carrier aggregation (CA) beam adjustment trigger condition is met, e.g., as described for steps 550 and/or 660. This evaluation may alternatively or in addition be performed at the UE. At 736, the respective other communication node may be informed about an activation of a carrier aggregation Tx beam adjustment such that in 738 in a lower-layer procedure, the UE may switch to the best or highest ranked TX beam or may compute a joint set of beamforming weights to optimize a TX beam. Further signals may be exchanged in 740, for example, that a deactivation of a CA beam adjustment/reselection is requested or that the adjustment is completed.

In other words, FIG. 7 presents a signal flow chart detailing the suggested signaling associated with swapping from PCC to SCC operation. FIG. 7 shows a schematic diagram of a signaling example of the network-based decision of the beamforming adjustment optimized for the best CC.

In certain carrier aggregation combinations, more than two component carriers may be used. In this case, the following method may be implemented (see also FIG. 6):
1.a. At any point during the active connection, e.g. UE in RRC_CONNECTED, BTS can request (additional) UE radio access capability information. The UE responds with the capability information. Relevant to this invention is the UE capability info that would indicate support for, transmit beam adjustment, which could also include additional parameters, such as number of antenna panels, maximum number of supported beams etc.

| | | |
|---|---|---|
| CA-ParametersNR ::= | SEQUENCE { | |
| CA-beamReselection | ENUMERATED {supported} | OPTIONAL, |
| SEQUENCE{ | | |
| multiplePanels | BOOLEAN, | |
| maxNumberOfBeams | INTEGER (1,...N) | |
| } | | |
| ... | | |
| } | | |

2. Establish carrier aggregation—add SCC to PCC.
3. Establish additional carrier aggregation—add further CCs to existing PCC and SCC.
4. Rank SCCs according to predefined criteria, for example, a wider bandwidth to the UE on a particular SCC and/or the best L1-RSRP/RSRQ/SINR or any other monitored signal quality metric on a particular SCC using relevant reference signals, or using feedback information provided by the base station. Ranking can be performed by a UE or gNB.
5. Perform UE TX beam adjustment optimized for 1st-ranked SCC
   a. UE-based decision
      The UE may be pre-configured/configured (according to the system specifications) with a condition or a set of conditions that will trigger Tx beam reselection optimized according to the specified criteria. An example of the condition could be the case when the feedback information from the network is received, indicating to the UE performance indicators from primary carrier and 1^{st} ranked SCC. The network may be configured, according to the system specification, to issue such an indication when the adopted signal quality metric hysteresis on gNB (receive side) 1^{st} SCC compared to PCC using the adopted metric, i.e. L1-RSRP/RSRQ/SINR on SRS, demodulation reference signals or any other relevant reference uplink signal, exceeds/falls below a predefined threshold.
      Once the condition is met, the UE can, for a given gNB RX beam on the 1st ranked SCC: i) switch to the best Tx beam, provided before; or ii) initiate the TX beam provisioning/sweeping procedure and compute/select combinatory set/joint set of beamforming weights, according to some predefined criteria. Note that if beam correspondence holds, the beam used for downlink reception is assumed to be suitable for the uplink transmission. Considering that this is a UE-based decision, the UE should also inform the base station about the beam adjustment/reselection, using uplink control information/channel. For example, an indication of the PCC/SCC beam selection or the optimized beam index can be multiplexed within the Channel State Information (CSI) report.
      b) Network-based decision
      The base station may decide after performing measurements on a set of provided UE TX beams, and based on a certain condition or a set of conditions, such as the received signal quality metric, such as L1-RSRP/RSRQ/SINR on SRS, demodulation reference signals or any other relevant reference uplink signal on PCC and 1st ranked SCC, or based on the available bandwidth on component carriers to request the UE to perform TX beam adjustment/reselection. For this, the base station can use the combination of RRC signaling and/or MAC Control Elements and/or Downlink Control Information. The UE can then, for a given gNB RX beam: i) switch to the indicated Tx beam; or ii) initiate the TX beam reselection/sweeping procedure and compute combinatory set/joint set of beamforming weights, according to the signaled criteria. If beam correspondence holds, the UE can consider using the beam requested and furthermore, the Tx beam corresponding to the best RX beam used for downlink reception.
6. Continue communication on all carriers where UE uses the beam optimized to the best CC, according to the predefined criteria

Embodiments provide for a device having the control unit 18 configured for receiving information indicating a joint set of beamforming weights, e.g., by receiving signal 22. The device 20 may be configured for receiving a first receive-beam sweeping request from the network and for performing a receive-beam sweeping process responsive to the first receive-beam sweeping request using the joint set of beamforming weights. The device may further be configured for receiving a second receive-beam sweeping request from the network and for performing a receive-beam sweeping for a transmission beam pattern indicated in the request responsive to abeam sweeping request as described in connection with 708. For example, the UE (device 20) may get the instruction from the network to switch CC and the UE may initiate the beam-sweeping procedure. The first receive-beam sweeping request and/or the second receive-beam sweeping request may be received by use of any signaling methods, for example, based on a radio resource control (RRC) signaling, a medium access control (MAC) control element, a downlink control information (DCI), uplink control information (UCI), side link control information and/or a combination thereof.

According to an embodiment, a device is provided as being configured for determining the joint set 24 of beamforming weights, i.e., to perform own calculations or to perform a lookup when having knowledge about the beam pattern to generate. The control unit 18 may be configured for performing a transmission-beam sweeping for a transmission beam pattern of the communication partner responsive to a result of an evaluation of a trigger condition, using the joint set of beamforming weights. For example, the device may be configured for using a transmission beam pattern that corresponds to a receive-beam pattern being adjusted based on the first and/or second transmission-beam sweeping request for an uplink transmission. Alternatively or in addition, the control unit may be configured for informing the network that the beam adjustment is completed.

As may be seen from FIG. 7, the device 20 and the communication partner 25 may be configured for jointly performing a beam management process or a beam adjustment process in an autonomous manner. However, such a process may also be orchestrated by a network entity, for example, when having sensing nodes distributed within the network that allow for jointly evaluating beam pattern characteristics.

The device and the communication partner may be configured for using a same or different matrix for beam selection during the beam management process or the beam adjustment process.

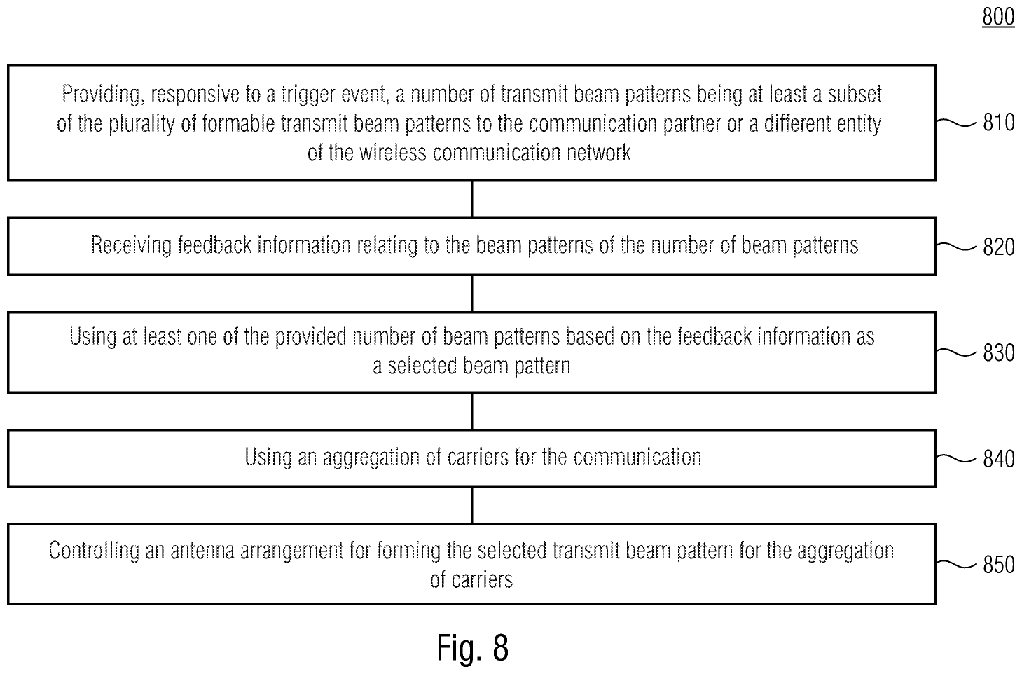

FIG. 8 shows a schematic flow chart of a method 800 that may be used for operating a device so as to operate in a wireless communication network with a communication partner within the wireless communication network. For example, the device may be controlled for exchanging a wireless signal. For example, the device may be controlled for performing communication with a communication partner within the wireless communication network by exchanging a wireless signal; wherein the device is configured for communicating with the communication partner using a beamforming technique to form a transmit beam pattern being a beam pattern selected from a plurality of transmit beam patterns being formable by the device For example, the method may be implemented so as to operate device 20.

A step 810 comprises providing, responsive to a trigger event, a number of transmit beam patterns being at least a subset of the plurality of formable transmit beam patterns to the communication partner or a different entity of the wireless communication network.

A step 820 comprises receiving feedback information relating to the beam patterns of the number of beam patterns.

A step 830 using at least one of the provided number of beam patterns based on the feedback information as a selected beam pattern.

A step 840 comprises using an aggregation of carriers for the communication.

A step 850 comprises controlling an antenna arrangement for forming the selected transmit beam pattern for the aggregation of carriers

Although in a particular situation it may be sufficient to implement only one of a network-based decision and a UE-based decision about the joint set of beamforming weights, i.e., the selection of beams. However, the decision may also be performed jointly.

The method 800 may optionally comprise establishing a connection to the communication partner using the first carrier and prior to aggregating the second carrier. Method 800 may further comprise transmitting information relating to the carrier aggregation to inform the communication partner about the aggregation in the first carrier as described, for example, in connection with FIG. 7.

Embodiments relate to a determination of a joint set of beamforming weights to be used for the aggregation of carriers. The set of beamforming weights may be selected, e.g., from a codebook or from a table being not a codebook, per se. Alternatively or in addition, the joint set of beamforming weights may be computed by the device itself, e.g., based on the particular component carrier being used and/or a compromise between all of the component carriers in use. Alternatively or in addition, the joint set of beamforming weights may be sent to the device by another device such as a higher network entity. Alternatively or in addition, the joint set of beamforming weights may be adapted by the device due to a change in the device performance, e.g., internal compensation/feedback/failure recovery/redundancy. That is, a specific trigger or evaluation may be used by the device. That is, the joint set may be a selected value or may be the result of a computation, adaptation, compensation or combination.

It is further noted that when having determined the joint set of beamforming weights which is to be understood as selecting the beam pattern to be generated, the second set of beamforming weights to be used for the second carrier is identical to the first set of beamforming weights used in the first carrier, when the joint set is applied. Embodiments related to calculating an optimum beamforming weight set for the first carrier having a first frequency range and another which is optimum for the second carrier at a second frequency range. That allows to obtain the beamforming weights 19₁ and 19₂. Those beamforming weights may rely on a same origin. After having determined the sets based on the frequency, it may be decided to apply either the first set or the second set for both frequencies in order to have it to be optimum for at least one of the two frequencies. As an alternative, a third set may be chosen for beamforming weights which is suboptimal for both frequencies but which degrades less according to a joint matrix across the two bands/frequencies/carriers. This does not mean to have two different sets of beam formers to be applied at the same time. In contrast, it is possible to calculate different sets of beam formers being optimum according to certain matrix but embodiments related to make a decision which one to choose. Furthermore, the whole mechanism may be described as means to make go selection on either side of the communication link and, in an embodiment, to orchestrate the selection process and metrics involved. This may include same or different criteria/metrics on both ends.

FIG. 9A shows a schematic block diagram of a control unit 90 according to embodiments, for example, control unit 18 of device 20. The control unit 90 may be configured for internal communication or control 52, for example to select, compute, adapt and/or combining sets of beamforming weights (BFW). For example, internal control may comprise access to a memory, providing beamforming weights to the antenna arrangement or the like,

Beside this, the control unit 90 may be configured for external communication or control. For example, external communication 54 may be related to exchange or communicate a request or instruction, e.g., to provide for the number of transmit beam patterns or to use a specific beam pattern for any purpose. An external communication 56 may be related to an exchange or communication of relevant configuration changes. An external communication 58 may relate to an exchange or communication of capabilities of devices, e.g., by use of the capability signal 28. An external communication 62 may relate to an exchange or communication of measurements, key parameter indicators (KPIs), decisions and/or observations, such as the feedback signal 22.

It may be understood that the control unit 90 may be implemented as one single unit or as a set of units that may be in communication with each other and/or may be arranged or placed at a same and/or different network entities. Each control unit may implement one or more of the named functionalities. The wireless communication network implements, in total, all of the functionalities, wherein some of those functionalities may also be optional such as the transmission of the capabilities.

FIG. 9B shows a schematic representation of a control unit 92 according to an embodiment which may, alternatively or in addition to the communication 52, 54, 56, 58 and/or 62 implement a signaling to and/or from a communication partner and/or a reporting 74 to and/or from a communication partner. Both may be referred to as external communication/signaling, e.g., using suitable channels. The signaling 72 may comprise, for example, an exchange of at least one request, of at least one instruction, of at least one requirement, at least one optimization criterion, and/or at least one capability. The reporting 74 may comprise, for example, an exchange or communication of at least one measurement or result thereof, at least one KPI, at least one decision made and/or at least one observation. Alternatively or in addition, the control unit may implement an internal communication or control 76 as was described for the internal signaling 52. This may be use to select, compute, adapt and/or combine beamforming weights.

FIG. 9C shows a schematic representation of a wireless communication network 900 which may be the wireless communication network 200, at least in parts. A device 95₁ and a device 95₂ of the wireless communication network 900 may be supplemented by further devices. Each device 95₁ and 95₂ (referred to as Device/Node A and Device/Node B) may comprise at least one transceiver chain, at least one antenna arrangement and at least one control unit, each control unit implementing at least a part of the functionality of control unit 90 not excluding redundancy of functionality. Devices 95₁ and 95₂ may form a communication partner for the respective other device. Each of the devices 95₁ and/or 95₂ may be implemented as a device 20.

FIG. 9D shows a schematic representation of a wireless communication network 950 according to an embodiment. When compared to the wireless communication network 900, additional devices 95₃ and 95₄, wherein devices 95₁ and 95₂ on the one hand and devices 95₃ and 95₄ on the other hand form a pair of communication partners, wherein embodiments are not limited to pairwise communication. However, device 95₄ which may not be needed to have a communication partner or even to be part of the wireless communication network 950 may determine interference from device 95₁ e.g., when being illuminated by a main lobe or side lobe of the transmit radiation pattern formed by device 95₁. Device 95₁ may thus implement an aggressor for victim 95₄. The device 95₄ may inform device 95₁ directly or indirectly about the perceived interference, thereby causing a trigger event. The optimization criterion considered by a shared/distributed control unit and/or the control unit of device 95₁ may this consider the interference at device 95₄ as well as the link quality for the aggregation to device 95₂. The network may thus perform a TX beam optimization on device A, a m3easuring and monitoring of desired link to device 95₂ and a measuring and monitoring of the aggressor at device 95₄. Device 95₄ may, for example, send additional feedback information to the feedback information of device 95₂.

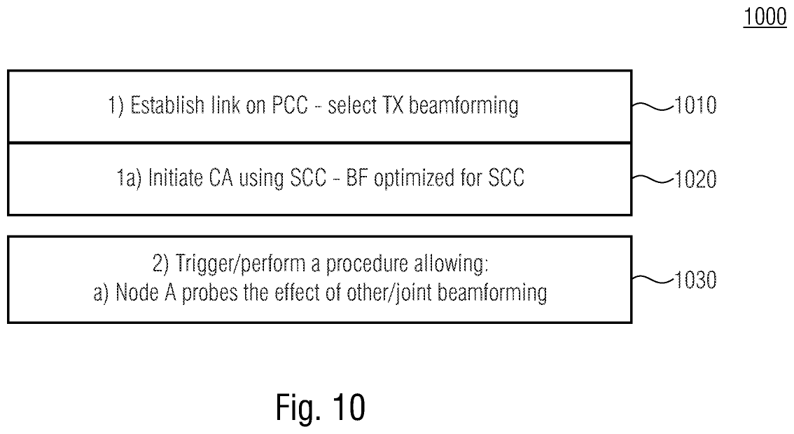

FIG. 10 shows a schematic flowchart of a method 1000 according to an embodiment. A step 1010 comprises establishing a link on PCC and a selection of a corresponding beamforming, i.e., a transmission beam pattern. A step 1020 that may also be a part of step 1010 may comprise initiation of carrier aggregation suing SCC and to use a beamforming that is optimized for SCC whilst being applied for the aggregation. A step 1030 may comprise recognition of a trigger that may lead to perform a procedure that allows that a node (Node A) such as the communication partner probes the effect of other joint beamformings.

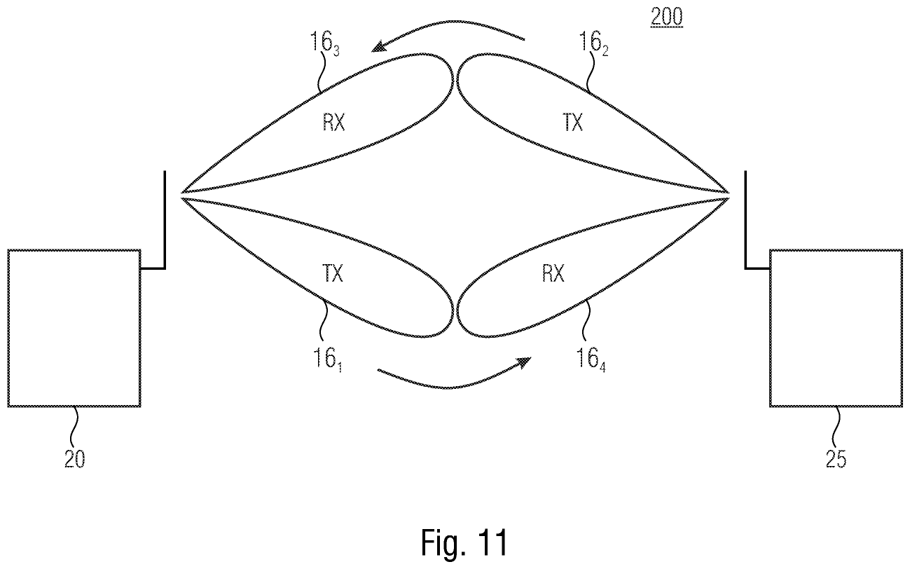

FIG. 11 shows a schematic block diagram of network 200 in which the device 20 and the device 25 both are capable for forming a transmission beam pattern 16₁ and 16₃ respectively and a reception beam pattern 16₂ and 16₄ respectively. Beam patterns 16 and 16₄ and beam patterns 16₂ and 16₃ may form pars of patterns that allow a transmission of signals spatially separated. That is both devices may be implemented, e.g., using their control units, to form transmission beam patterns and reception beam patterns. The weights for the transmission beam patterns 16₁ and 16₂, i.e., deciding the beam pattern, may be decided at device 20 based on Rx beam selection mechanisms which may be performed autonomously and/or at device 20. Alternatively or in addition, the decision may be performed at least in parts at device 20 with assistance from device 25 using prediction on performance, at least one indicator or the like. Alternatively or in addition, the decision may be performed at least in parts at device 25 or a different network entity selecting or requesting a particular codebook entry, i.e., a transmit beam pattern to be applied for the at least two carriers of the aggregation at device 20.

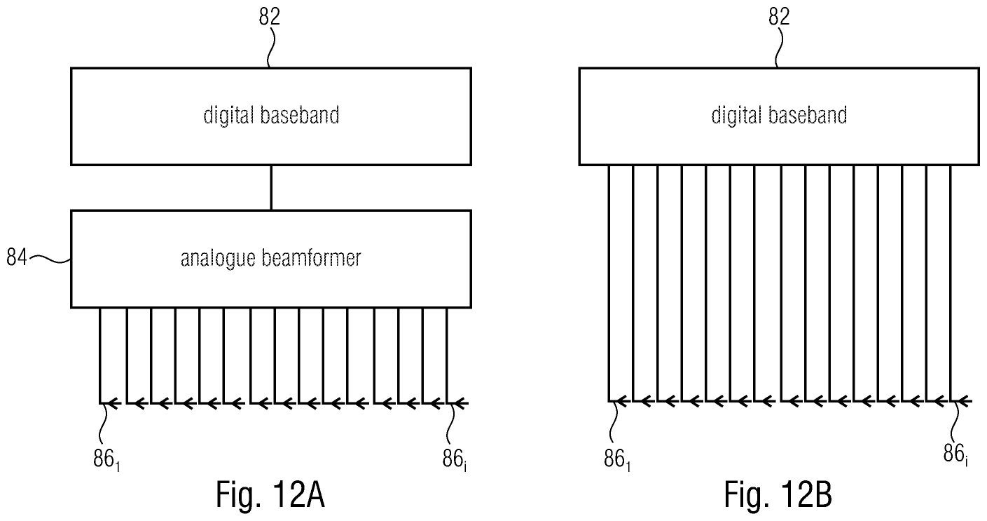

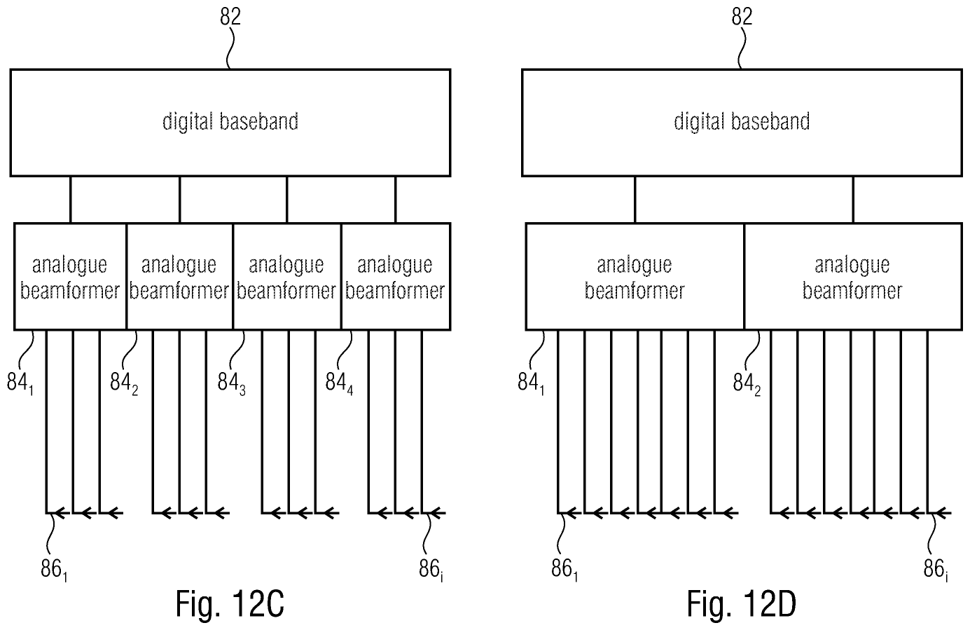

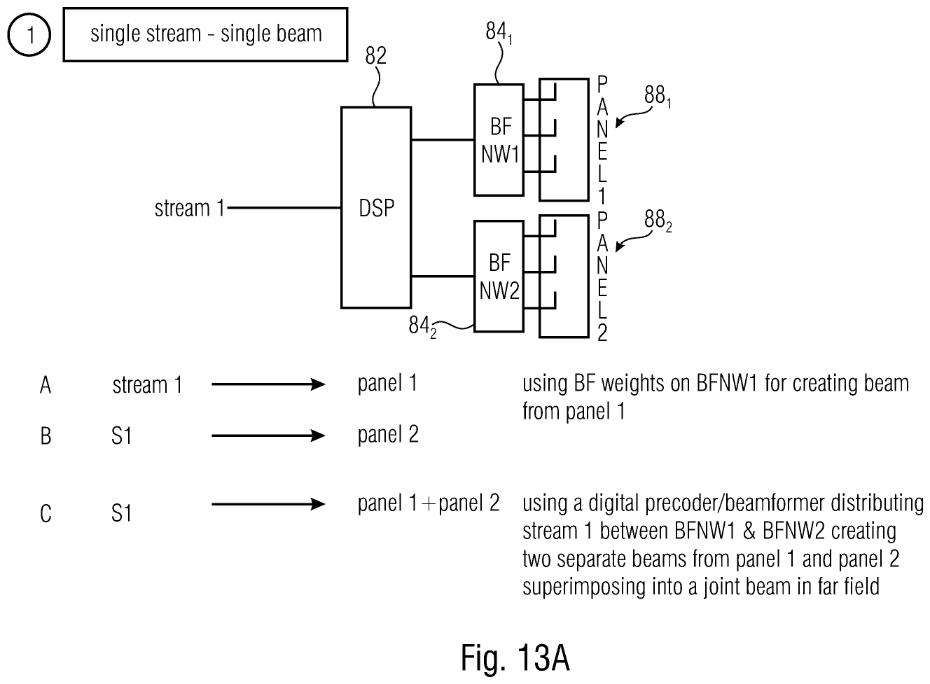

FIG. 12A shows a schematic representation of an analog beamformer in which a digital baseband 82 is connected to an analogue beamformer 84 that is connected to the antenna elements 86₁ to 86ᵢ of the antenna arrangement so as to control all of them. FIG. 12B shows, in contrast, a digital beamformer in which the digital baseband 82 is connected to the antenna elements 86₁ to 86ᵢ so as to allow for independent transceiver chains. FIGS. 12C and 12D show schematic representations of hybrid beamformers in which analogue beamformers 84₁ to 84₄, 84₁ and 84₂ respectively are connected to a subset of antenna elements only but, therefore, more than one analogue beamformer is used. The number of antenna elements connected to an analogue beamformer in the hybrid case may be same or different amongst the beamformers. Further, a number of antenna elements and analogue beamformers may be selected arbitrarily.

When considering the number of antenna arrays or antenna panels used in a device and the number of beams and/or streams that the device is capable of producing, also in connection with the device being able to operate with a single component carrier or multiple component carriers, is summarized in the table below.

| | Number | Number | | |
|---|---|---|---|---|
| | of | of beams | | |
| | arrays or | and/or | Single | Multiple |
| Index | panels | streams | CC | CC |
| A | Single | Single | Yes | Yes |
| B | Single | Multiple | Yes | Yes |
| C | Multiple | Single | Yes | Yes |
| D | Multiple | Multiple | Yes | Yes |

While analogue beamforming implementation methods (“A”) are described in the embodiments, digital methods (“B”) and hybrid methods (“C”) should are not excluded from the embodiments. Since a set of beamforming weights is associated with “A”, “B” and “C”, the combinatory aspect of the embodiments may make provision for new sets of beamforming weights to be formed from “A” and “C”.

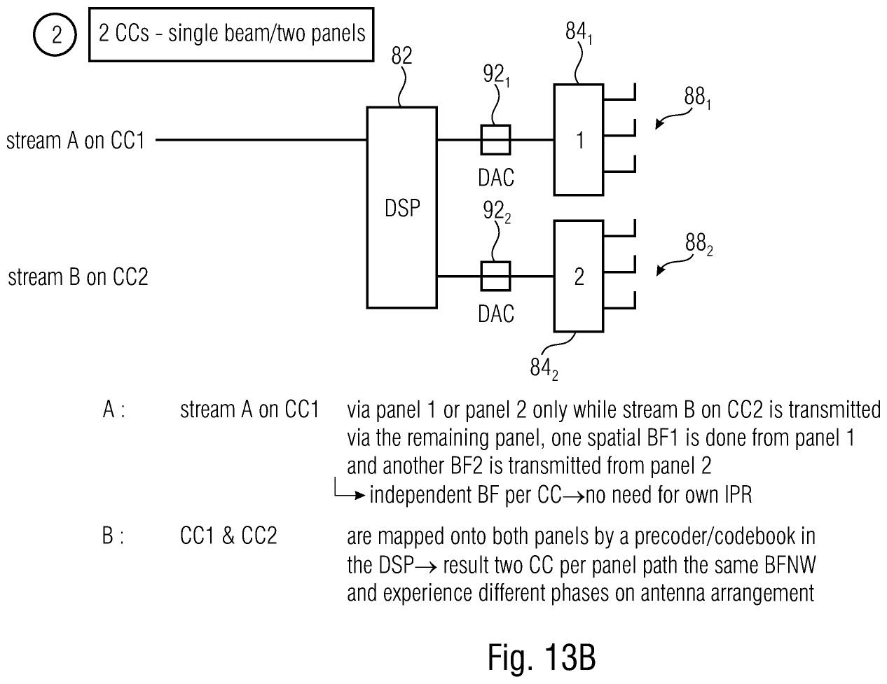

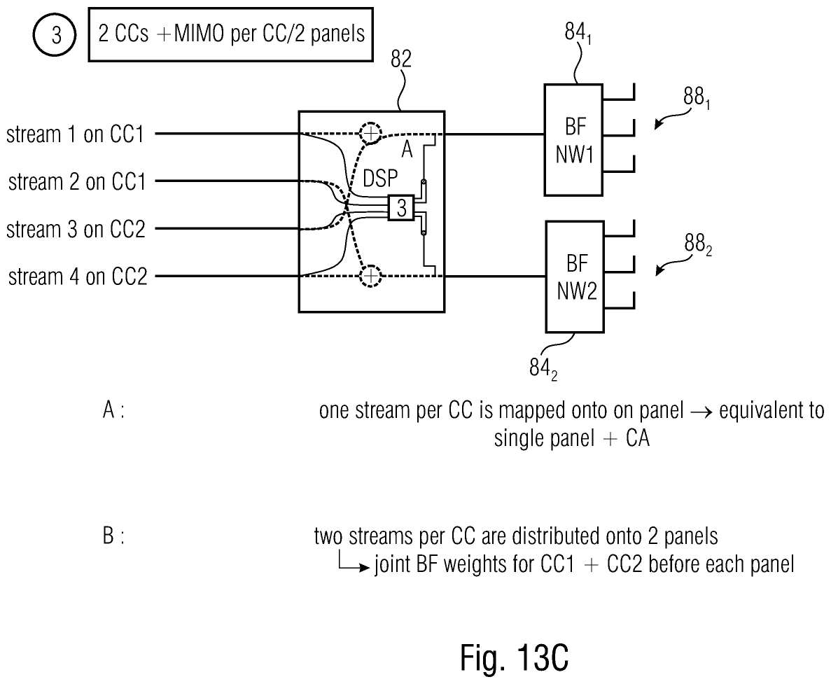

FIG. 13A shows, whilst making reference to the hybrid beamforming of FIGS. 12C and 12D a configuration according to an embodiment, where the digital signal processing 82 is connected to two beamforming networks or analogue beamformers 84₁ and 84₂, each being connected to an antenna panel (Panel 1 and Panel 2) having same or different number of antenna elements. Stream one, i.e., a signal may be provided to digital baseband 82 and provided to both beamformers, i.e., to panel 1 and panel 2, whilst for panel 1, beamforming weights are used on beamforming network 1 for creating a transmit beam pattern on panel 1, see step A. In Step B, the stream 1 may also be provided to panel 2 such that in step C panel 1 and panel 2 use a digital precoder or beamformer 82 distrivbuting stream 1 between beamforming networks 84₁ and 84₂ for creating two separate beams from panels 1 and 2 superimposing into a joint beam in the far field. That is, FIG. 13A shows a configuration of single stream, single beam according to an embodiment.

FIG. 13B shows a configuration according to a use of two component carriers with a single beam at two panels. Digital signal processing (DSP) 82 may receive two streams/signals A and B on, e.g., on different CCs. Each stream may be provided to a respective beamformer 84₁ and 84₂ to supply a panel 88₁, 88₂ respectively. Digital to analog-converters (DAC) 92₁ and 92₂ may be connected between the DSP 82 and the beamformers 84₁ and 84₂. That is, in step A, stream A on CC is transmitted via panel 1 or panel 2 only where stream B on CC2 is transmitted via the remaining panel, one spatial beamformer is done for panel 1 and one spatial beam is transmitted from panel 2. This may allow for independent beamformers per CC. According to an a step B, CC1 and CC2 are mapped onto both panels by a precoder/codebook in the DSP resulting in two CC per panel path the same beamforming network and experience different phases on the antenna arrangement.

FIG. 13C shows an arrangement in which DSP 82 receives streams 1 to 4 (or any other number) on a respective number of CCs, wherein one stream per CC is mapped onto one panel which is equivalent to single panel using carrier aggregation as shown for path “A”. in “B”, two streams per CC are distributed onto 2 panels allowing joint beamforming weights for CC1 and CC2 before feeding them to each panel. FIG. 13C may be referred to as 2 CCs plus MIMO (multiple input multiple output per CC and 2 panels.

Embodiments relate to beam refinement and beam correspondence. Whilst beam management may be understood as offering a certain set of beams, more appropriately with reference signals (RS) to the communication partner, the other end of the communication link/partner may respond providing an indication which beam to select in the future for communication and in some cases providing cite conditions for further signaling information, a beam correspondence or beam refinement may work on the basis that the receiver on one side or on both sides (N) may receive a signal, optimizes its receive beamforming weights according to a suitable metric and then uses a transmit beam which corresponds “best” to the radiation pattern of the receive beam. Thereby, the principle of propagation path reciprocity may be exploited. Embodiments, however, relate to a combination of beam management and beam correspondence, still keeping it an open issue which beamforming weights may be used if only one set of beamforming weights can be used for the different carriers/frequency bands in combination. This issue is solved by determining the joint set 24 of beamforming weights.

In connection with beam management, embodiments may implement one or more of the following:

Pattern Control

In the context of the preceding discussion, and in order to form the best link between devices (for example a base station and a piece of user equipment), beam management may be used to ensure that the beams of each device are pointing appropriately.

Antenna arrays may allow to generate transmission radiation patterns and/or reception radiation patterns. For example, in connection with reception or sensing a signal. An array of sensor elements may offer a means of overcoming the directivity limitations associated with a single sensor (antenna), thus offering higher gain and narrower beamwidth than that experienced with a single element. In addition, an array has the ability to control its response based on changing conditions of the signal environment, such as direction of arrival, polarization, power level and frequency [3].

An array consists of or may comprise two or more sensors in which the signals are coherently combined in a way that increases the antenna's performance. Arrays used in embodiments may have the following advantages over a single sensor:
1. Higher gain. The gain is higher, because the array gain is on the order of the number of elements in the array. Higher resolution or narrower main beam follows from the larger aperture size.
2. Electronic beam scanning. Physically or mechanically moving large antennas to steer the main beam is slow. Arrays with phase shifters at each element are able to steer the beam without mechanical motion, because the signals are made to add in phase at the beam steering angle.
3. Low sidelobes. If the desired signal enters the main beam while interfering signals enter the sidelobes, then lowering the sidelobes relative to the main beam improves the signal to interference ratio.
4. Multiple beams. Certain array feeds allow simultaneous multiple main beams.
5. Adaptive nulling. Adaptive arrays automatically move nulls in the directions of signals over the sidelobe region
6. Beam/link performance resilience against movements, mobility, rotation of the device or against co-channel interference from other links operated in the same location area.
7. Beam/directions might be advantageous in preparation of e.g. handover procedures or in the context of resilience against blockage e.g. a selection of a radiation pattern which covers a larger angular range and therefore is not as prone to blockage than a narrow field of view/angular opening of the radiation pattern.

In addition to the reception advantages described above, an array also offers considerable benefits when used for transmission purposes, too.

Regardless of whether the array is used for transmission or reception purposes, it is normally needed to provide a means by which the array's antenna radiation pattern can be controlled for the following reasons: to point one or more beams in given directions; to control the direction and relative level of sidelobes; or to control the position and relative depth of nulls.

An example for controlling an antenna radiation pattern may be explained in connection with phased antenna arrays. The examples provided relates to measures to be implemented at or between antennas of an antenna array.

It is noted that objections exist about the term phased array antenna for a scanned beam array antenna, based on the fact that a non-scanned array antenna is still in fact a phased array antenna, as its operation relies on relative phases between the elements. Notwithstanding this argument, the term phased in connection with beam-steered, will be used thereby following the historical development. [3] The term beam former will also be used regardless of whether only a single beam or multiple beams are created and whether the beamforming is involving weights in the digital, analogue domain only or combinations of the two.

A phased array is typically comprised of a number of antenna elements arranged in two- or three-dimensional space. The position of the elements with respect to one another is generally fixed—in other words, they do not move in their own array space. This does not however exclude phased array systems from portable and mobile applications. The elements of an array can be arranged geometrically so as to be linear, planar or conformal in either a regular or an irregular manner. Combinations of the aforementioned categories are also possible.

In the case of a fully digital beam forming system, the antenna elements may be individually connected to their own a transmitter or receiver or transceiver circuit. Alternatively, in an analogue beam forming system, more than one antenna element may be connected to a common radio circuit via either a series- or corporate-feed network. The number of elements per radio is determined by system requirements and design constraints. A so-called hybrid beam forming system combines both digital and analogue implementations.

Almost regardless of the method used to implement the beam former—digital, analogue or hybrid—it is the excitation of its elements that determines certain radiation characteristics of the array. In order to control such properties, for example the direction in which a beam is directed, the phase of individual element excitation is to be configured appropriately. Similarly, sidelobe levels, as discussed below can be controlled through amplitude tapers.

Realization of Phase Shifting

Having explained the reason for controlling the phase excitation of array antenna elements, this section outlines four example methods that are available for accomplishing a desired phase shift.

Changing Frequency

Phase shifting by changing frequency or frequency scanning is accomplished by series feeding the array antenna elements whereby the elements are equidistantly positioned along the feed line. By changing the frequency, a changing linear phase taper over the array antenna elements is created, since the input signal has to travel over a physical distance and thus electrical length to reach the i^{th} element of the K-element linear array antenna. If the physical lengths of the feeding lines are chosen such that at the center frequency, the phased array antenna beam is directed perpendicular to the array or to broad-sight, changing the frequency to values lower than and greater than the center frequency will direct the beam to, respectively, angles smaller than and angles greater than broad-sight [3]. When a phased array is used for communication purposes however, in which a fixed frequency channel assignment is typical, it is impractical to implement phase shifting by changing the frequency of operation.

Changing Length

This type of phase shifting may be applied to series-fed arrays, as well as to corporate-fed arrays, [4]. In the pre-digital era, phase shifters based upon changing physical length were realized by electromechanical means. The line stretcher [4] is an example of an early type of phase shifter. The line stretcher is a (coaxial) transmission line section, bent in the form of a ‘U’. The bottom part of this ‘U’ is attached to the two ‘arms’ that form part of the stationary feeding network. The bottom part of the ‘U’ acts as a telescoping section that may be stretched by electromechanical means, thus lengthening and shortening the transmission line section, without changing the position of the ‘arms’ of the ‘U’ [3].

Nowadays, different lengths of transmission line are selected digitally. The switches in every section are used to either switch a standard length of transmission line into the network or to switch a piece of transmission line of a predetermined length that adds to this standard length. These lengths are chosen such that when the cascade of the standard length is taken as reference (having a phase ψ=0°), 16 phases (corresponding to 4 bits), ranging from ψ=0° to ψ=337.5°, in steps of 22.5° (least significant bit) may be selected. Higher resolution can be achieved by using shorter lengths and more bits. PIN diodes—employed in forward and reverse bias—are often used as switching elements [4, 5]. The switched phase shifters may be realized in microstrip technology, using high dielectric constant substrate material, thus minimizing physical phase shifter dimensions [3].

Another way of switching physical line lengths is found in the cascaded hybrid-coupled phase shifter. A 3 dB hybrid is a four-port device that divides the power at input port 1, equally over output ports 2 and 3 and passes no power to output port 4. The reflections of the signals that have left ports 2 and 3 return into the hybrid and combine at output port 4, none of the power being returned to input port 1. The diode switches in every segment (bit) of the cascaded hybrid-coupled phase shifter are either returning the signals leaving ports 2 and 3 directly, or after having travelled the extra line length ΔI/2 twice. As an example, a four-bit phase shifter ΔI/2=λ/32 for the least significant bit, and for the following three bits, respectively, ΔI/2=λ/16, ΔI/2=λ/8 and ΔI/2=λ/4 [3].

A Butler matrix is a further example of a beamforming network and comprises an N×N matrix of hybrid couplers and fixed-value phase shifters where n is some power of two. The device has both N input ports (the beam ports) and N output ports (the element ports) to which N antenna elements are connected. The Butler matrix feeds power to the elements with a progressive phase difference between elements such that a beam is produced in the desired direction. The beam direction is controlled by switching power to the desired beam port. More than one beam, or even all N of them can be activated simultaneously. The Butler matrix can be used for both transmission and reception purposes. It offers the advantage over other methods of angular beamforming through simplicity of hardware implementation since it needs far fewer phase shifters than other methods and can be implemented in microstrip on a low-cost printed circuit board.

Changing Permittivity (Dielectric Constant)

By adjusting the current that flows through a device containing a gaseous discharge or plasma, its dielectric constant and hence phase shift can be controlled [4]. Another way to adjust the permittivity of a device is through the use of so-called ferro electric materials in which the permittivity is a function of the electric field applied over the material [3]. The permittivity may be adjusted between the antennas of the antenna array.

Changing Permeability

Ferrimagnetic materials, or ferrites, are materials for which the permeability changes as function of the change in an applied magnetic field in which the material is positioned. Ferrite-based phase shifters have been in use for a long time, especially in combination with waveguide transmission line technology. In the case of the Reggia-Spencer phase shifter [4]—which consists of a rod of ferrimagnetic material, centrally positioned inside a waveguide, where a solenoid is wound around the waveguide—the phase can be changed continuously, making the phase shifter analogue in nature. On the other hand, the function of the solenoid can be performed by a current wire through a ferrimagnetic rod. By cascading different lengths of ferrimagnetic rods, different (discrete) phase shifts may be realized, thus making such phase shifter digital in nature [3]. The permeability may be adjusted between the antennas of the antenna array.

As discussed, also amplitude tapers may be used, e.g., to control sidelobes.

The strength or amplitude of the element excitation—also known as the element weight-controls the directivity and sidelobe level of the array factor. Examples of amplitude tapers include binomial, Dolph-Chebyshev, Tseng-Cheng-Chebyshev, Taylor, Taylor-Woodard, Hansen, Bickmore-Spellmire and Bayliss [6]. Low-sidelobe amplitude tapers have high amplitude weights in the center of the array and the weights generally decrease from the center to the edges. In general, as the taper efficiency decreases, the half-power beamwidth increases and the sidelobe levels decrease.

Amplitude Realization

Amplitude excitation adjustment of antenna elements can be realized by controlling the gain of amplifier stages which, depending on the implementation of the system, could include digital gain, intermediate frequency (IF) gain and radio frequency (RF) gain settings for both the transmitter and receiver chains. Where appropriate, active signal amplification can also be implemented in frequency translation stages by, for example, controlling the drive level of local oscillator devices connected to mixer devices. In addition to the aforementioned active devices that introduce signal amplification, passive devices can also be used which, due to their nature, attenuate signals rather than amplify them. Examples of such devices include power dividers or splitters, coupled lines or couplers, transformers, impedance converters, resistive networks and parasitic elements.

Adaptive Arrays

An adaptive array may comprise an algorithm which is possibly computer-based and that controls the signal levels at the elements until a measure of the quality of the array performance improves. It may adjust its pattern formed, i.e., the antenna radiation pattern, to form nulls, to modify gain, to lower sidelobes, or to do whatever it takes to improve its performance. An adaptive array offers enhanced reliability compared with that of a conventional array. When a single sensor element/antenna element in a conventional array fails, the sidelobe structure of the array pattern degrades. With an adaptive array, however, the remaining operational sensors in the array automatically adjust so as to restore the pattern. For this reason, adaptive arrays are more reliable than conventional arrays, since they fail gracefully. The reception pattern of an array when installed on a structure such as a tower or a vehicle, or when held in the hand, placed next to the head, or worn on the body, is often quite different from the array pattern measured in isolation (in an anechoic chamber) as a result of signal scattering that occurs from vehicle structures in the vicinity of the antenna or from interaction with the user. An adaptive array may yield successful operation even when antenna patterns are severely distorted by near-field effects. The adaptive capability overcomes a lot of or even any distortions that occur in the near field and merely responds to the signal environment that results from any such distortion. Likewise, in the far field the adaptive antenna is oblivious to the absence of any distortion [6].

An adaptive array may improve the SINR/SIR by preserving the main beam that points at the desired signal at the same time that it places nulls in the pattern to suppress interference signals. Very strong interference suppression may be possible by forming pattern nulls over a narrow bandwidth. This exceptional interference suppression capability is a principal advantage of adaptive arrays compared to waveform processing techniques, which generally need a large spectrum-spreading factor to obtain comparable levels of interference suppression. Sensor arrays possessing this key automatic response capability are sometimes referred to as “smart” arrays, since they respond to far more of the signal information available at the sensor outputs than do more conventional array systems [6].

Method for Assessing a Link Performance of a Device

The embodiments described thus far concerned the device combining beamforming and carrier aggregation, the wireless communication network including the device and the method for operating the device. However, the present invention is not limited to such embodiments. In accordance with further embodiments, the present invention provides a method for assessing a link performance of a device as described in the above embodiments. In other words, embodiments of the present invention provide a method which finds application to the testing, measurement, qualification and certification of a user equipment or a communication device of a wireless communication network that, when operating, combines beamforming and carrier aggregation.

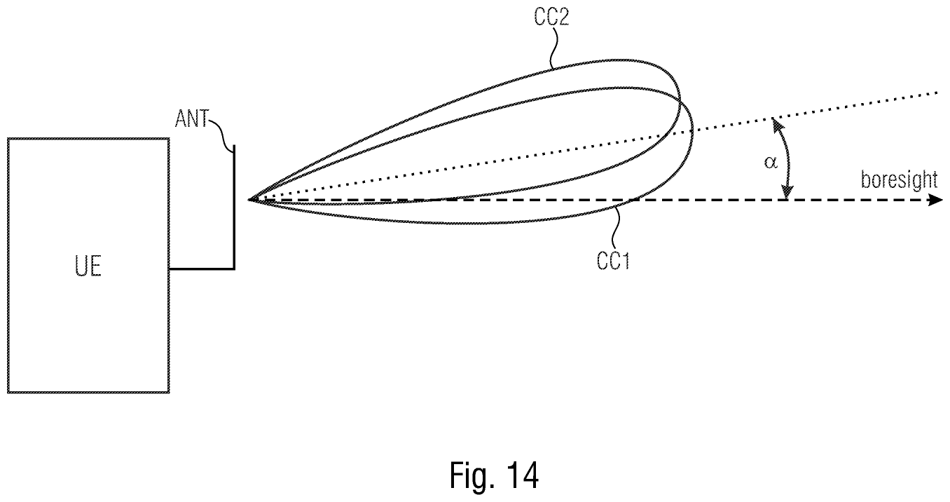

FIG. 14 schematically illustrates a UE, like a device described above in more detail, having one or more array antennas ANT. In the context of beamforming by using an antenna array, which has a plurality of antenna or array elements, to transmit/receive a plurality of component carriers CC1 and CC2 or bandwidth parts which are stretching over a larger spectral region, e.g. from several hundred megahertz to several gigahertz, the array element spacing may not be perfectly matched to the desired spacing, like a lambda/2 spacing, for all component carriers CC1, CC2 or bandwidth parts of a component carrier at the same time. For non-boresight beam directions, this frequency dependent mismatch causes a squinting of the beams that is illustrated in FIG. 14. The effect of beam squinting is a function of the array mismatch, compared to optimum spacing, like the lambda/2 spacing, and the deviation of the targeted main lobe direction from the boresight of the antenna array. This means that the two beam formed component carriers CC1 and CC2 experience more deviation of their main lobe directions when beamformed with the same antenna array using common beamforming weights, e.g., provided by phase shifters, delay lines, attenuators. The beam squint occurs when an incremental phase difference or time delay is applied to the elements in the antenna array. For example, when operating at a frequency corresponding to CC1 and when the CC1 beam points in the boresight direction, if there is not any inter-element phase difference then the absolute phase or time delay is the same for all elements. At the same time and without changing the beamformer optimized for CC1, when operating at a second frequency corresponding to CC2, the CC2 beam also points in the boresight direction since, again, there is no incremental phase shift between antenna elements. However, when the beam is electronically scanned away from boresight, an incremental phase difference or time delay is created by the beamformer and applied to the elements of the antenna array. This produces the beam squint shown in FIG. 14. The beam squint is a function of the array operating frequency versus the electronic scan angle α, and when the scan angle α is zero or, in other words, at boresight there is no beam squinting. This is also true when the array is operated at its design frequency. The larger the difference in central frequency between the two component carriers, the more the main beam direction of the second component carrier CC2 deviates from the boresight of a planar array. In terms of system performance another factor comes into play—with an increased array gain obtained from a larger amount of antenna elements per array dimension a beam becomes more narrow which means any deviation from a specific direction has relatively more impact on the effective power transmitted into a particular direction away from the main peak direction. For example, the 3 dB beamwidth becomes effectively smaller with increasing array gain or an increase in the number of antenna elements per array dimension. It is noted that the planar antenna array ANT is just one example of an array antenna configuration. The beam squinting effect is experienced in any other form of antenna array as well.

As described above, the beam squinting occurs because the component carriers are beam formed by the same antenna array using common beamforming weights optimized for one of the components carriers. However, beam squinting may also be experienced when beam forming the component carriers by different antenna arrays using different beamforming weights optimized for the respective component carrier. In other words, beam squinting may also be experienced in devices or UEs that neither use a common antenna array nor use a common beamformer. Such devices may use separate antenna arrays and/or separate beamforming means for the purpose of transmission and reception. Since the antenna arrays used for different purposes may comprise a different number of antenna elements and the antenna elements used in these arrays may have different characteristics, and furthermore as it is impossible for two arrays to exactly reside in the same space at the same time, the beam squinting effect may also exist in other practical realizations that do not use a common antenna array and a common beamformer for all component carriers. Moreover, certain devices may realize their design using multiple antenna panels, for example, at opposite ends or on opposite sides or faces of the device, and also here beam squinting may exist.

For devices as described herein that combine beamforming and carrier aggregation, it may be desired to assess the link performance achievable by such a device, e.g., over a certain range of relative angular positions between the device or its antenna and a receiver. To address this issue, embodiments of the present invention provide an approach for testing a device as described herein to allow for qualifying or quantifying an achievable link performance of the device.

The present invention provides a method for assessing a link performance of a device for a wireless communication system, wherein the device is to beamform a plurality of component carriers using common beamforming weights, the plurality of component carriers comprising at least a first component carrier (PCC) and a second component carrier (SCC), the method comprising:
(a) beamforming a first beam pattern for the first and second component carriers (PCC, SCC) using the common beamforming weights, wherein the common beamforming weights are selected such that the first beam pattern is optimized for the first component carrier (PCC) according to one or more predefined criteria,
(b) measuring one or more signal metrics of the first and second component carriers (PCC, SCC) transmitted in accordance with the first beam pattern,
(c) beamforming a second beam pattern for the first and second component carriers (PCC, SCC) using the common beamforming weights, wherein the common beamforming weights are selected such that the second beam pattern is optimized for the second component carrier (SCC) according to one or more predefined criteria,
(d) measuring one or more signal metrics of the first and second component carriers (PCC, SCC) transmitted in accordance with the second beam pattern, and
(e) comparing the one or more signal metrics measured in steps (b) and (d) for qualifying or quantifying the link performance.

In accordance with embodiments, the device comprises a plurality of antenna elements, and wherein the first and second component carriers (PCC, SCC) are beamformed using the same antenna elements.

In accordance with embodiments, step (a) comprises controlling the plurality of antenna elements for beamforming the first beam pattern for the first and second component carriers (PCC, SCC), and step (c) comprises controlling the plurality of antenna elements for beamforming the second beam pattern for the first and second component carriers (PCC, SCC).

In accordance with embodiments, the plurality of antenna elements comprises some or all antenna elements of one or more antenna arrays of the device that are activated for beamforming.

In accordance with embodiments, the first and second component carriers (PCC, SCC) are beamformed by antenna elements that
are distributed over a plurality of antenna arrays of the device, or
belong to only one of a plurality of antenna arrays of the device, or
are selected from available antenna elements of one or a plurality of antenna arrays of the device.

The present invention provides a method for assessing a link performance of a device for a wireless communication system, wherein the device is to beamform a plurality of component carriers using respective beamforming weights, the plurality of component carriers comprising at least a first component carrier (PCC) and a second component carrier (SCC), the method comprising:
(a) beamforming a first beam pattern for the first component carrier (PCC) using first beamforming weights, wherein the first beamforming weights are selected such that the first beam pattern is optimized for the first component carrier (PCC) according to one or more predefined criteria, and beamforming a second beam pattern for the second component carrier (SCC) using second beamforming weights, wherein the second beamforming weights are selected such that the second beam pattern is optimized for the second component carrier (SCC) according to one or more predefined criteria,
(b) measuring one or more signal metrics of the first component carrier (PCC) transmitted in accordance with the first beam pattern, and one or more signal metrics of the second component carrier (SCC) transmitted in accordance with the second beam pattern, and
(c) comparing the signal metrics measured in step (b) for the first and second component carriers for qualifying or quantifying the link performance.

In accordance with embodiments, the device comprises a plurality of antenna elements, and wherein the first and second component carriers (PCC, SCC) are beamformed by different antenna elements.

In accordance with embodiments, step (a) comprises controlling a first plurality of antenna elements for beamforming the first beam pattern for the first component carrier (PCC), and controlling a second plurality of antenna elements for beamforming the second beam pattern for the second component carrier (SCC).

In accordance with embodiments,
the first plurality of antenna elements comprises some or all antenna elements of one or more antenna arrays of the device that are activated for beamforming, and
the second plurality of antenna elements comprises some or all antenna elements of one or more antenna arrays of the device that are activated for beamforming.

In accordance with embodiments, the first and second component carriers (PCC, SCC) are beamformed by different antenna elements that
are distributed over a plurality of antenna arrays of the device,
belong to only one of a plurality of antenna arrays of the device,
are selected from available antenna elements of one or a plurality of antenna arrays of the device.

In accordance with embodiments, qualifying or quantifying the link performance comprises one or more of the following:
qualifying or quantifying a difference or a degradation of the link performance when using the first and second beam patterns,
obtaining a link performance difference per component carrier versus beamformer selected according to a criterion relevant for a first component carrier and a second component carrier,
obtaining a link performance difference variation per component carrier versus beamformer selected according to a criterion relevant for a first component carrier and a second component carrier,
qualifying or quantifying an uplink or downlink performance when using the first and second beam patterns according to a beam correspondence criterion selected at the device,
qualifying or quantifying an uplink or downlink performance when using the first and second beam patterns according to a criterion selected.

In accordance with embodiments, the method comprises
establishing a link between the device, like a UE, and a transceiver, performing the controlling and measuring for a downlink transmission from the transceiver to the device, wherein the first and second beam patterns are first and second receive beam patterns,
performing the controlling and measuring for an uplink transmission from the device to the transceiver, wherein the first and second beam patterns are first and second transmit beam patterns, and
comparing the one or more signal metrics measured for qualifying or quantifying a downlink performance, and an uplink performance.

In accordance with embodiments, the receiver comprises
the device is located at a measurement site or in a measurement environment including a measurement equipment, ME, the ME comprising the transceiver, or
the device is located in the wireless communication network, and the transceiver comprises one or more other entities, like a base station or another UE, of the wireless communication network.

In accordance with embodiments, steps (a) to (e) are performed for a plurality of different relative angular configurations or directions between the device and the transceiver, like a plurality of different angular configurations or directions relative to a boresight of an antenna array of the device towards an antenna of the transceiver.

In accordance with embodiments, the method comprises
aggregating one or more signal measurements obtained in steps (b) and (d) for the different angular configurations or directions, e.g., using a Cumulative Distribution Function, CDF, or a Complementary Cumulative Distribution Function, CDDF, and comparing the aggregated metrics.

In accordance with embodiments, for each of the plurality of different relative angular configurations or directions,

step (a) comprises:
optimizing a receive beam at the device for the first component carrier in the downlink, and
optimizing a transmit beam at the device for the first component carrier in the uplink, step (b) comprises:
measuring and recording a received signal strength or power in the downlink at an antenna measurement port of the device for the first and second component carriers, and
measuring and recording a received signal strength or power in the uplink at the transceiver for the first and second component carriers,
   step (c) comprises:
optimizing a receive beam at the device for the second component carrier in the downlink, and
optimizing a transmit beam at the device for the second component carrier in the uplink, and
   step (d) comprises:
measuring and recording a received signal strength or power in the downlink at an antenna measurement port of the device for the first and second component carriers, and
measuring and recording a received signal strength or power in the uplink at the transceiver for the first and second component carriers.

In accordance with embodiments, the first and second beam patterns or the transmit and receive beams are optimized using beam management procedures or beam correspondence.

In accordance with embodiments, one or more of the following is measured:
a signal strength or power,
an effective or equivalent isotropic radiated power, EIRP,
a bit error rate, BER, or packet error rate, PER,
received signal strength indicator, RSSI, variations,
one or more radiation pattern measurements, like one or more of
   a beam peak direction,
   a pattern null direction and null depth,
   a sidelobe direction,
   a sidelobe level relative to main beam peak
   a maximum gain,
   a half-power beamwidth,
   a first sidelobe level,
   a front-to-back ratio,
   a position of a first null,
   a cross-polarization ratio.

In accordance with embodiments, the device is a device according to the present invention.

The following description of embodiments of the measurement method of the present invention is applicable to the assessment of devices that may experience the effects of beam squinting regardless of the mechanism through which the effect was created or generated. In other words, the method is equally applicable to the measurement or testing of devices that aggregate multiple component carriers using
the same antenna array for a plurality of component carriers; or
different antenna arrays and/or beamforming means for each component carrier; or
a combination of the same or different antenna arrays and/or beamforming means.

When assessing the resulting impact of beam squinting on the link performance contributed by a wireless device using beam forming on aggregated carriers, such a device may be tested in-situ, i.e., when being deployed within the wireless communication system, or in a measurement environment exploiting the change or exchange of the lead component carrier in an suitable adapted manner.

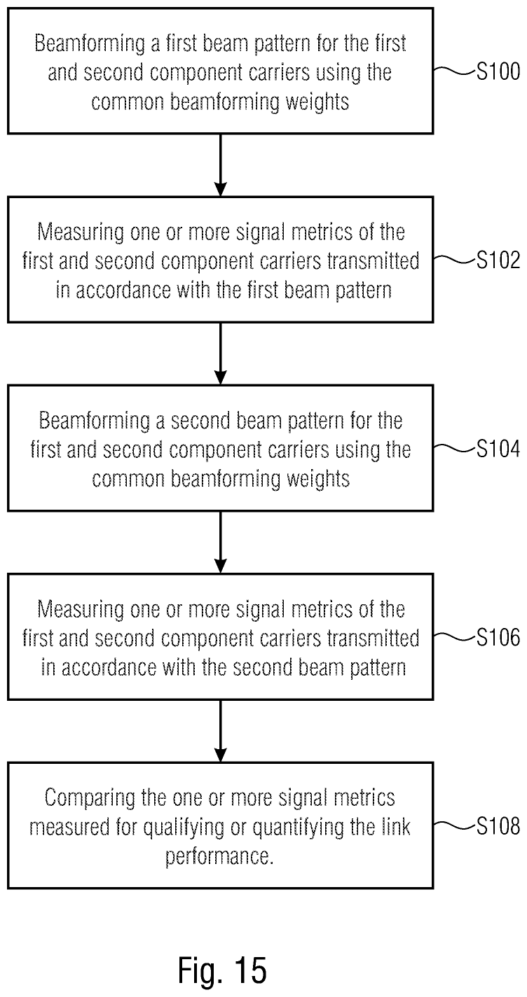

FIG. 15 is a flow diagram illustrating a first embodiment of the inventive measuring or testing process assuming a device, like user equipment, UE, for a wireless communication system that beamforms a plurality of component carriers CC1, CC2 using common beamforming weights. The plurality of component carriers includes at least a first or primary component carrier PCC or CC1 and a second or secondary component carrier SCC or CC2. In a first step S100, a first beam pattern for the first and second component carriers PCC, SCC is beamformed using the common beamforming weights. The common beamforming weights are selected such that the first beam pattern is optimized for the first component carrier PCC according to one or more predefined criteria.

In a second step S102, one or more signal metrics of the first and second component carriers PCC, SCC transmitted in accordance with the first beam pattern are measured.

In a second step S104, a second beam pattern for the first and second component carriers PCC, SCC is beamformed using the common beamforming weights. The common beamforming weights are selected such that the second beam pattern is optimized for the second component carrier SCC according to one or more predefined criteria.

In a fourth step S106, one or more signal metrics of the first and second component carriers PCC, SCC transmitted in accordance with the second beam pattern are measured.

In a fifth step S108, the one or more signal metrics measured in steps 102 and 106 are compared for qualifying or quantifying the link performance.

In accordance with embodiments, the device has a plurality of antenna elements, and the first and second component carriers PCC, SCC are beamformed using the same beamforming enabling components including e.g. antenna elements, phase shifters, delay lines, attenuators or other suitable means. For example, the device may include a beamforming network that includes one or more beamforming components, like phase shifters, delay lines, attenuators and the like. When beamforming the component carriers, within the beamforming network a common set of beamforming components associated with a set of antenna elements may be used for beamforming the first and second component carriers. In step 100, the plurality of antenna elements may be controlled for beamforming the first beam pattern for the first and second component carriers PCC, SCC, and in step 104 the same plurality of antenna elements may be controlled for beamforming the second beam pattern for the first and second component carriers PCC, SCC.

The plurality of antenna elements may include some or all antenna elements of one or more antenna arrays of the device that are activated for beamforming. In other words, according to embodiments, the first and second component carriers PCC, SCC may be beamformed by antenna elements that
are distributed over a plurality of antenna arrays of the device, or
belong to only one of a plurality of antenna arrays of the device, or
are selected from available antenna elements of an antenna array of the device For example, the available antenna elements may comprise antenna elements of a single antenna array, or one or more antenna elements of two or more of the antenna arrays.

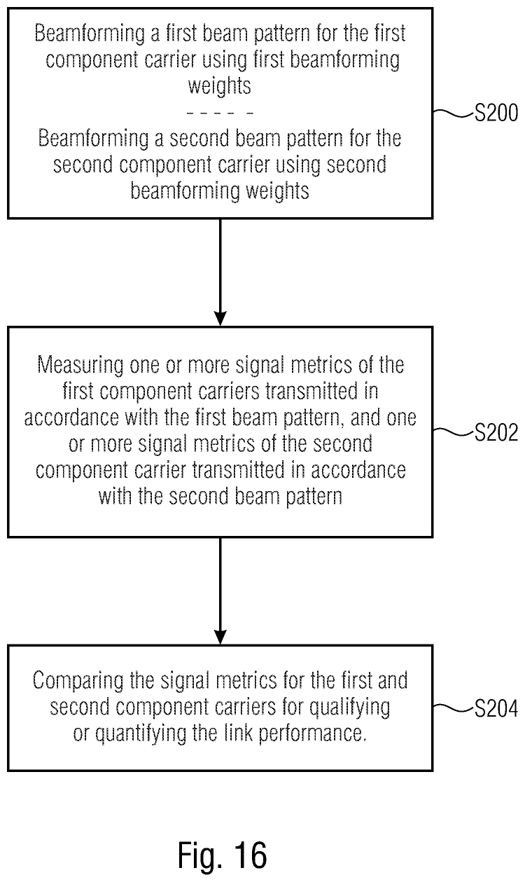

FIG. 16 is a flow diagram illustrating a second embodiment of the inventive measuring or testing process assuming a device, like a user equipment, UE, for a wireless communication system that beamforms a plurality of component carriers using respective beamforming weights. The plurality of component carriers includes at least a first component carrier PCC or CC1 and a second component carrier SCC or CC2. In a first step S200, a first beam pattern for the first component carrier PCC is beamformed using first beamforming weights. The first beamforming weights are selected such that the first beam pattern is optimized for the first component carrier PCC according to one or more predefined criteria. At the same time, i.e., also during step S200, a second beam pattern is beamformed for the second component carrier SCC using second beamforming weights. The second beamforming weights are selected such that the second beam pattern is optimized for the second component carrier SCC according to one or more predefined criteria.

In a second step S202, one or more signal metrics of the first component carrier PCC transmitted in accordance with the first beam pattern, and one or more signal metrics of the second component carrier SCC transmitted in accordance with the second beam pattern are measured.

In a third step S204, the metrics measured in step 202 measured for the first and second component carriers are compared for qualifying or quantifying the link performance.

In accordance with embodiments, the device has a plurality of antenna elements, and the first and second component carriers PCC, SCC are beamformed by different antenna elements. The device may include a beamforming network that includes one or more beamforming components, like phase shifters, delay lines, attenuators and the like. When beamforming the component carriers by different antenna elements, within the beamforming network a first set of beamforming components associated with a first set of antenna elements is used for beamforming the first component carrier, and a second set of beamforming components associated with a second set of antenna elements is used for beamforming the second component carrier. In step 200, the first set or plurality of antenna elements may be controlled, e.g., using the first set of beamforming components of the beamforming network, for beamforming the first beam pattern for the first component carrier PCC, and a second set or plurality of antenna elements may be controlled, e.g., using the second set of beamforming components of the beamforming network, for beamforming the second beam pattern for the second component carrier SCC.

Each of the first set of antenna elements and the second set of antenna elements may include some or all antenna elements of one or more antenna arrays of the device that are activated for beamforming, with the first and second sets comprising different antenna elements. In other words, the elements of the first set may be some or all of the elements of one or more arrays. The antenna elements of the second set are different from the first set of antenna elements but the antenna elements of the second set may also be some or all of the elements of one or more arrays. Thus, the two sets of antenna elements may be taken from different arrays or from the same arrays.

In other words, the first and second component carriers PCC, SCC may be beamformed by different antenna elements that
are distributed over a plurality of antenna arrays of the device, or
belong to only one of a plurality of antenna arrays of the device, or
are selected from available antenna elements of one of a plurality of antenna arrays of the device. For example, the available antenna elements may comprise antenna elements of a single antenna array, or one or more antenna elements of two or more of the antenna arrays.

The above-mentioned antenna arrays may include several subarrays, and one or more subarrays of one antenna array may be used in combination with one or more subarrays belonging to another antenna array for creating the joint beam. An antenna array may comprise a digital interface or RF input on the one end towards the digital signal processing elements of the device, and a beamforming network towards the other direction ending at the antenna elements or antenna element connectors. If the beamforming network is not capable of configuring and applying independent beamforming coefficients for different CCs at the same time then effectively the signals of one CC or all aggregated CCs pass through the this common beamforming network into the two possible directions, like UL and DL.

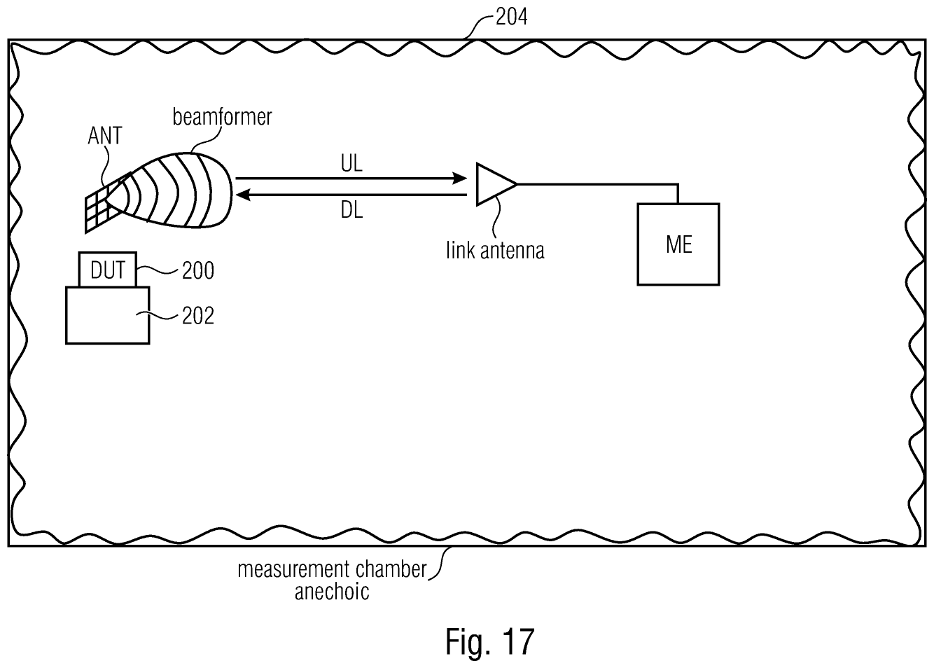

In the following, embodiments are described which, for assessing the beam squinting effect, place the UE in a certain measurement environment. When being placed or located within a measurement environment, the UE is also referred to as a device under test, DUT. FIG. 17 illustrates a DUT 200 mounted to a 3D positioner 202, like a turntable, within a measurement chamber 204, like an anechoic measurement chamber. The measurement environment includes a link antenna LA connected to a measurement equipment ME, e.g., acting as a base station, BS, when the DUT is a UE. The UE or DUT 200 is equipped with an array antenna ANT used for beamforming a received signal to optimize the link performance in the downlink, DL, from the ME to the DUT 200, and for beamforming a transmit beam to optimize the link performance in an uplink, UL, from the DUT 200 to the ME.

To assess the effect of beam squinting on link performance, the following measurement procedure is proposed in accordance with embodiments of the present invention. The UE or DUT 200 is mounted to the positioner 202 which enables a relative angular movement of the DUT 200 or its antenna array ANT with respect to the link antenna, LA, like a horn antenna. The link antenna LA is positioned at a suitable distance from the DUT 200 and is connected to the measurement environment ME. The ME acts as a communication partner or counterpart for the DUT 200, for example, when the DUT is a user equipment, UE, the ME may act as a base station BS.

For the purpose of assessing beam squinting due to (a) the frequency separation between a first component carrier CC1 and a second component carrier CC2 and (b) the beam direction angle or scan angle relative to the boresight of the array antenna, the DUT 200 is arranged with a given angular configuration or direction towards the link antenna LA. The DUT 200 establishes a link with the ME such that the DUT is operating in an RRC connected state during which the DUT attempts to optimize the downlink performance by selecting an appropriate receive beam, using for example a reference signal from the ME. Through use of the antenna test port, the received signal power per component carrier may be measured at the DUT 200 and the result may be reported to the ME using existing test mode commands. The received beam is optimized for a primary component carrier PCC or CC1. At the same time, and because the link is aggregating component carriers, a secondary component carrier SCC or CC2 also passes through the same antenna array elements and beamformer used by the PCC. Due to the difference in CC frequencies, the beams associated with the PCC and the SCC are not directed in exactly the same angular direction and do not have identical strengths due to the embedded analogue phase shifting, delay changing and/or amplitude changing elements operating at different frequencies. The difference between the antenna pattern associated with CC1 and CC2 is related to a number of parameters not limited to include the following: the operating frequency; the difference in CC frequencies; the scan angle; the design of the antenna array and its elements; and the design of the beamformer.

In the uplink or reverse link, a similar procedure is applied from the DUT 200 to the ME, and the transmit beam is optimized for the PCC using either beam management procedures or beam correspondence. Beam correspondence describes a relationship between a best receive beam selected by a DUT and a transmit beam the DUT selects autonomously or semi-autonomously. Since in the CA scenario the beam correspondence is operated on the first or the second CCs, the other CC experiences potential performance degradation due to the beam squinting. The same array beamforming weights are applied for the SCC passing through the beamformer and the array antenna. Provided that the transmitted power on both the PCC and SCC is known or at least kept constant over various measurement points, i.e., a relative angle pair, between the boresight of the antenna array ANT and the link antenna LA, the received power at the link antenna LA is observed and monitored by the ME. Thus, the performance assessment may be done for various relative positions or directions or angles between the DUT 200 and the LA. The angles may be chosen to cover a dense grid around the DUT 200 to allow an assessment of links into many directions that may be represented as points on the surface of an imaginary sphere.

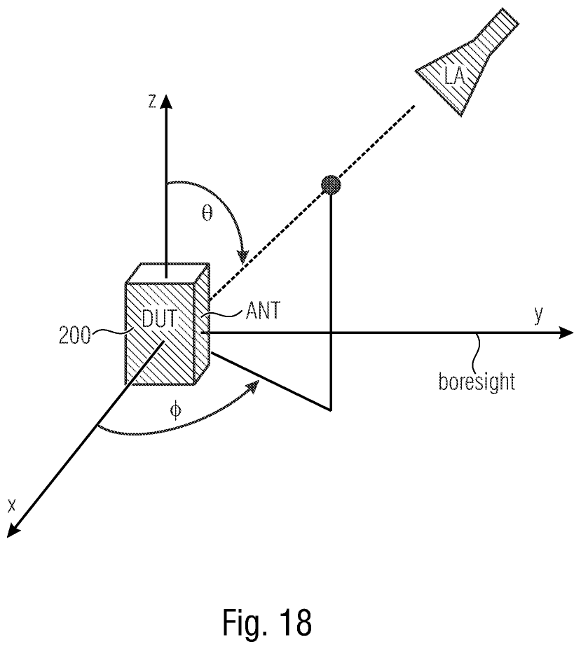

FIG. 18 illustrates a coordinate system geometry based on IEEE Std 149-1979 and showing the DUT 200 and the link antenna LA. The relative angular configuration or direction between the DUT 200 and the LA is labelled by the angles theta θ and phi ϕ. In accordance with embodiments, to assess the beam squinting effect on the link performance in both UL and DL, the following measurement procedure is proposed for each angular position θ[1 . . . i] & ϕ[1 . . . j]:

Step 1: Use of a Joint Beamformer Optimized for CC1:

1.1 Downlink Link Performance—Measured at the DUT/UE Side
optimize a receive beam at the DUT 200 for CC1 in the DL in accordance with a reference signal from the LA, and
measure and record a received signal strength or power in the DL at the antenna measurement port of the DUT/UE 200 for CC1 and CC2,

1.2 Uplink Link Performance—Measured at ME/BS Side
optimize a transmit beam at the DUT 200 for CC1 in the UL in accordance with beam management or beam correspondence, and
measure and record a received signal strength or power in the UL at the ME/BS for CC1 and CC2

Step 2: Joint Beamformer Optimized for CC2:

2.1 Downlink Link Performance—Measured at the DUT/UE Side
optimize a receive beam at the DUT 200 for CC2 in the DL in accordance with a reference signal from the LA, and
measure and record a received signal strength or power in the DL at the antenna measurement port of the DUT/UE 200 for CC1 and CC2

2.2 Uplink Link Performance—Measured at the ME/BS Side
optimize a transmit beam at the DUT 200 for CC2 in UL in accordance with beam management or beam correspondence, and
measure and record a received signal strength or power in the UL at the ME/BS for CC1 and CC2

Step 3 (Pointwise Comparison of Measurements from Step 1 and Step 2):
compare the measurement results from step 1 and step 2 for:
   the downlink according to a selected metric, and
   a the uplink according to a selected metric

For all measured angular positions [1 . . . i]x[1 . . . j], a direct and quantitative assessment of the link performance in both UL and DL due to the effect of optimizing the antenna and beamformer for one particular component carrier as to another may be made by comparing one or more of the following:
the received power difference;
the associated SNR;
the throughput at the receiver;
the BER/PER at the receiver.

During such assessments, a fixed power transmission level per CC may be used in steps 1 and 2. However, when this is not possible, the difference in power level may be recorded and used in subsequent compensations.

The pointwise measurements may be further consolidated by statistical operations, e.g. by using a Cumulative Distribution Function, CDF, or a Complementary Cumulative Distribution Function, CDDF, depending on the targeted insight and/or defined criterion for passing a conformance and/or performance test. The above described pointwise measurements may be understood as one embodiment for realizing or implementing the inventive measurement procedure, in accordance with which the UE or DUT is positioned at a relative angular position with respect to the receiver's antenna. The relative position or direction may be described by a selected angle pair theta and phi as shown in FIG. 18. For each angle pair a measurement is performed, and the measurement results are stored for further post-processing. However, the present invention is not limited to such embodiments.

In accordance with other embodiments, the measurement may be made along a continuous curve or path on a sphere or trajectory. In accordance with further embodiments specific measurement points described by theta and phi may be selected along a continuous angular path or movement. In other words, while moving the UE or DUT in the theta/phi domain in a stepwise, segment-wise or continuous manner the measurements may be performed and stored at the receiver side and/or at the UE side. Specific measurements, which are conducted at particular angular positions, may be marked by suitable markers, like time stamps allowing the two-sided measurements in UL and DL to be correlated during the post-processing. The trajectory or movement or path of a connecting line between the antenna array at the UE or DUT and the link antenna at the ME cutting the sphere around the DUT may be chosen to cover a selected segment of the sphere to be covered by the antenna array under test. The selected segments may be disjoint, complementing or overlapping for providing a more comprehensive and complete picture of the spherical coverage or performance to be assessed.

In accordance with yet other embodiments, an arbitrary cloud of measurement points may be obtained. Since the assessment of spherical segments may be time consuming, only a number or a subset of measurement points may be used that is sufficient to fulfill certain statistical criteria. In accordance with such embodiments, e.g., as an alternative to a continuous path described above with measurements along the path or to a fixed measurement grid defined on the sphere, arbitrary measurement points or angular positions may be chosen. When fulfilling a statistical performance metric such a method has the advantage of not being dependent on a particular deterministic distribution of the measurement points across the sphere in combination with a repeated way of mounting and pointing of the DUT on the mount within the measurement chamber. Although a smaller number of measurement points is obtained so that, when compared to the preceding embodiments, the point density into particular directions may be sparse, this may be compensated by an increase in the number of measurement points.

In accordance with embodiments, the assessment
qualifies or quantifies a difference or a degradation of the link performance when using the first and second beam patterns, and/or
obtains a link performance difference per component carrier versus beamformer selected according to a criterion relevant for a first component carrier and a second component carrier, and/or
obtains a link performance difference variation per component carrier versus beamformer selected according to a criterion relevant for a first component carrier and a second component carrier, and/or
qualifies or quantifies an uplink or downlink performance when using the first and second beam patterns according to a beam correspondence criterion selected at the UE, and/or
qualifies or quantifies an uplink or downlink performance when using the first and second beam patterns according to a criterion selected.

In order to assess the link performance one or more of the following may be measured:
a signal strength or power,
an effective or equivalent isotropic radiated power, EIRP,
a bit error rate, BER, or packet error rate, PER,
received signal strength indicator, RSSI, variations,
one or more radiation pattern measurements, like one or more of
   a beam peak direction,
   a pattern null direction and null depth,
   a sidelobe direction,
   a sidelobe level relative to main beam peak
   a maximum gain,
   a half-power beamwidth,
   a first sidelobe level,
   a front-to-back ratio,
   a position of a first null,
   a cross-polarization ratio.

Although the measurement process has been described so far to take place in a certain measurement environment, in accordance with other embodiments, the measurement process may be in-situ, i.e., the link performance of a UE being deployed or located in a wireless communication network and being in an RRC connected state may be assessed in accordance with the above described process. In that case, the UE, other than in FIG. 17, is located at a certain location and is connected to another entity of the network, like another UE and/or a base station, and the antenna LA is an antenna of the other entity. The measurement results may be communicated to a certain entity, like the UE or the other entity or to a core entity for assessing the link performance.

In-situ measurements may also be desired as, other than in a well-defined measurement environment, the performance in a real environment may differ, e.g., due to a user interaction with e.g. head and hands. Furthermore, the beam squinting effect may relax or increase due to multipath propagation which is not considered or tested in a test setup. Therefore, it is also beneficial to measure the effective impact of beam squinting when a device is connected to a network or communicating with another device in-situ, in other words in a live network. In an in-situ measurement setup the two communication partners may coordinate their interactions by a kind of test-mode, which may be complemented by specific means provided by the regular or normal operational mode design for a communication between a UE and a base station or gNB. The relative angular relationship between the UE and the base station may be difficult to determine accurately due to a lack of a well-defined coordinate system, nevertheless stationarity and/or relative movements or rotations of an in-situ device under test may be detected and measured by internal sensors, e.g., gyros, inside the UE or another handheld device. Therefore, before activating beam forming and carrier aggregation, an over-the-air, OTA, performance evaluation may be initiated by continuously measuring the beam squinting effect for particular component carrier candidates which are available at the network side. The measurement may be performed, e.g. in a static situation or a mobility situation, for providing enough sample points to either assess a spherical segment around the UE or with regard to a particular link situation, e.g. a static link which may benefit from CA.

In-situ measurements also allow a base station to self-test its own performance, e.g. after a software update and where distributed UEs in the field may be considered distributed link antennas when compared to the measurement scenario described with reference to FIG. 17. Thus, the device or DUT may be a UE or a BS or any other device suitable as a communication partner in a network or suitable to test a device to be used in a network and to be tested for conformance or performance assessment or for maintenance, commissioning or optimization purposes.

Embodiments of the present invention have been described above with reference to a device, like a UE, employing two component carriers, i.e., beamforming and combining two component carriers. However, the present invention is not limited to such embodiments. Rather, the inventive approach described above may be applied to the testing or measuring a device employing more than two component carriers, e.g., to devices beamforming and combining five or even more component carriers. In accordance with yet further embodiments, the device, in addition to the plurality of component carriers, may transmit and/or receive further signals, like radio signals for a communication with other entities in the network, or radar signals for distance measurements.

Embodiments of the present invention have been described above with reference to a device beamforming and combining component carriers using the same antenna elements or using different antenna elements. However, the present invention is not limited to such embodiments. Rather, the inventive approach described above may be applied to the testing or measuring a device providing multiple component carriers by beamforming and combining two or more component carriers using the same antenna elements and by beamforming and combining two or more additional component carriers using different antenna elements.

Embodiments of the present invention have been described above with reference to a device, like a UE. However, the present invention is not limited to such embodiments. Rather, the inventive approach described above may apply to any entity of a wireless communication network. In accordance with embodiments of the present invention, the device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground-based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink with/to the wireless communication network, e.g., a sensor or actuator, or any sidelink capable network entity.

In accordance with further embodiments of the present invention, the device may be one or more of the following: a macro cell base station, or a small cell base station, or a central unit of a base station, or a distributed unit of a base station, or a road side unit (RSU), or a remote radio head, an integrated Access and Backhaul (IAB) node or any transmission/reception point, TRP, enabling an item or a device to communicate using the wireless communication network, the item or device being provided with network connectivity to communicate using the wireless communication network.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] T. S. Rappaport, R. W. Heath Jr, R. C. Daniels, and J. N. Murdock, Millimeter wave wireless communications. Pearson Education, 2014
[2] E. Dahlman, S. Parkvall and J. Skold, 5G NR: The Next Generation Wireless Access Technology, 1st Edition, Academic Press, Elsevier, 2018
[3] Hubregt J. Wisser, “Array and Phased Array Antenna Basics”, Wiley, Chichester, 2005
[4] R. C. Johnson (ed.), “Antenna Engineering Handbook”, 3^{rd} Ed., McGraw-Hill, New York, 1993
[5] Merill I. Skolnik, “Introduction to Radar Systems”, 2^{nd} Ed., McGraw-Hill, Auckland, 1981
[6] Randy Haupt, “Antenna Arrays: A computational Approach”, Wiley, 2010

1. A device configured for operating in a wireless communication network and for performing communication with a communication partner within the wireless communication network by exchanging a wireless signal; wherein the device is configured for communicating with the communication partner using a beamforming technique to form a transmit beam pattern being a beam pattern selected from a plurality of transmit beam patterns being formable by the device;
wherein the device is configured for providing, responsive to a trigger event, a number of transmit beam patterns being at least a subset of the plurality of formable transmit beam patterns to the communication partner or a different entity of the wireless communication network;
wherein the device is configured for receiving feedback information relating to the beam patterns of the number of beam patterns; and
wherein the device is configured for using at least one of the provided number of beam patterns based on the feedback information as a selected beam pattern; and
wherein the device is configured for using an aggregation of carriers for the communication;
wherein the device comprises an antenna arrangement and a control unit configured for controlling the antenna arrangement for forming the selected transmit beam pattern for the aggregation of carriers.

2. The device of claim 1, wherein the device is configured for selecting, based on the feedback information, the at least one selected beam pattern by considering an optimization criterion relating to the communication within the wireless communication network.

3. The device of claim 1, wherein the device is configured for providing, responsive to the trigger event, the number of transmit beam patterns to the communication partner or a different entity of the wireless communication network; wherein the feedback information indicates a beam pattern of the provided number of beam patterns; wherein the device is configured for using the indicated beam pattern as the selected beam pattern or to evaluate that a different beam pattern is to be used as selected beam pattern.

4. The device of claim 3, wherein the device is configured for using the indicated beam pattern if no conflict is found during an evaluation of the feedback information; and/or for using the different beam pattern is a conflict is found during the evaluation.

5. The device of claim 1, wherein the each transmit beam pattern of the number of provided beam pattern is adapted to at most one single carrier of the aggregation; wherein the device is configured for using the re-selected beam pattern jointly for all carriers of the aggregation.

6. The device of claim 1, wherein the feedback information comprises information that indicates a best beam/beam pattern amongst the provided number of beams/beam patterns in view of the optimization criterion and/or comprises information indicating all beam patterns below (e.g. causing interference) or above (e.g. throughput gain) a given threshold.

7. The device of claim 1, wherein the feedback information comprises information that indicates that the indicated beam pattern comprises a joint performance metric for the aggregation of carriers above or below a predefined threshold for the communication partner and/or for a different entity of the network.

8. The device of claim 1, wherein the device is configured for establishing communication with the communication partner using a first carrier and a first transmit beam pattern; and for aggregating a second carrier to the first carrier to acquire the trigger event; and for selecting the transmit beam pattern and for using the selected transmit beam pattern jointly for the aggregation of carriers.

9. The device of claim 1, wherein the device is configured for providing the number of transmission beam patterns based on a beam sweeping of a specific transmission beam pattern.

10. The device of claim 9, wherein the device is configured for receiving the feedback information indicating the specific beam/beam pattern, wherein the device is configured for receiving a first transmission-beam sweeping request from the network, and for performing a transmission-beam sweeping process responsive to the first transmission-beam sweeping request using the specific beam pattern; and for receiving a second transmission-beam sweeping request from the network and for performing a transmission-beam sweeping for a transmission beam pattern indicated in the second request responsive to the second transmission-beam sweeping request.

11. The device of claim 10, wherein the device is configured for receiving the first transmission-beam sweeping request and/or the second transmission-beam sweeping request by use of at least one of signaling methods being based on:
a radio resource control (RRC) signaling;
a medium access control (MAC) control element;
downlink control information (DCI);
uplink control information (UCI);
side link control information and
a combination thereof.

12. The device of claim 1, wherein the optimization criterion relates to the communication with the communication partner and/or to interference caused at other entities of the wireless communication network.

13. The device of claim 1, wherein the device is configured for further selecting the transmit beam pattern without variation in the aggregation of carriers based on the trigger event.

14. The device of claim 1, wherein the device is configured for selecting the transmit beam pattern based on a continuous frequency range being spanned by a lowest frequency and a highest frequency of the aggregation.

15. The device of claim 1, wherein the antenna arrangement is an antenna panel of the device that is holistically controlled by the device.

16. The device of claim 1, wherein the device is configured for transmitting, to an entity of the wireless communication network, a capability information indicating a capability of the device to perform carrier aggregation and a capability to perform beamforming for the communication and/or receiving such capability information relating to another device.

17. A device configured for operating in a wireless communication network and for performing communication with a communication partner within the wireless communication network by exchanging a wireless signal;
wherein the device is configured for transmitting, to an entity of the wireless communication network a capability information indicating a capability of the device to perform carrier aggregation and a capability to perform beamforming for the communication and/or receiving such capability information relating to another device.

18. The device of claim 17, configured for transmitting the capability information so as to indicate a number of antenna arrays or antenna panels used for communication; a number of radio antenna patterns generatable by the device and to whether carrier aggregation is supported, e.g., by indicating a number of carriers that can be aggregated; or is unsupported.

19. A method for assessing a link performance of a device for a wireless communication system, wherein the device is to beamform a plurality of component carriers using common beamforming weights, the plurality of component carriers comprising at least a first component carrier (PCC) and a second component carrier (SCC), the method comprising:
(a) beamforming a first beam pattern for the first and second component carriers (PCC, SCC) using the common beamforming weights, wherein the common beamforming weights are selected such that the first beam pattern is optimized for the first component carrier (PCC) according to one or more predefined criteria,
(b) measuring one or more signal metrics of the first and second component carriers (PCC, SCC) transmitted in accordance with the first beam pattern,
(c) beamforming a second beam pattern for the first and second component carriers (PCC, SCC) using the common beamforming weights, wherein the common beamforming weights are selected such that the second beam pattern is optimized for the second component carrier (SCC) according to one or more predefined criteria,
(d) measuring one or more signal metrics of the first and second component carriers (PCC, SCC) transmitted in accordance with the second beam pattern, and
(e) comparing the one or more signal metrics measured in (b) and (d) for qualifying or quantifying the link performance.

20. The method of claim 19, wherein (a) to (e) are performed for a plurality of different relative angular configurations or directions between the device and the transceiver, like a plurality of different angular configurations or directions relative to a boresight of an antenna array of the device towards an antenna of the transceiver.

21. The method of claim 20, comprising
aggregating one or more signal measurements acquired in (b) and (d) for the different angular configurations or directions, e.g., using a Cumulative Distribution Function, CDF, or a Complementary Cumulative Distribution Function, CDDF, and
comparing the aggregated metrics.

22. A method for assessing a link performance of a device for a wireless communication system, wherein the device is to beamform a plurality of component carriers using respective beamforming weights, the plurality of component carriers comprising at least a first component carrier (PCC) and a second component carrier (SCC), the method comprising:
(a) beamforming a first beam pattern for the first component carrier (PCC) using first beamforming weights, wherein the first beamforming weights are selected such that the first beam pattern is optimized for the first component carrier (PCC) according to one or more predefined criteria, and beamforming a second beam pattern for the second component carrier (SCC) using second beamforming weights, wherein the second beamforming weights are selected such that the second beam pattern is optimized for the second component carrier (SCC) according to one or more predefined criteria,
(b) measuring one or more signal metrics of the first component carrier (PCC) transmitted in accordance with the first beam pattern, and one or more signal metrics of the second component carrier (SCC) transmitted in accordance with the second beam pattern, and
(c) comparing the signal metrics measured in (b) for the first and second component carriers for qualifying or quantifying the link performance.
